(19) United States
(12) Patent Application Publication
(10) Pub. No.: US 2007/0273983 A1
(43) Pub. Date: Nov. 29, 2007

(54) DEVICES, METHODS, AND SYSTEMS FOR IMAGE VIEWING

(76) Inventor: Raymond T. Hebert, Florence, OR (US)

Correspondence Address: GANZ LAW, P.C., P O BOX 2200, HILLSBORO, OR, 97123, US

(21) Appl. No.: 11/420,624

(22) Filed: May 26, 2006

(51) Int. Cl. G02B 13/18

(52) U.S. Cl. 359/708

(57) ABSTRACT

Devices, methods and systems for image viewing. Various example embodiments of devices, methods and systems for image viewing are disclosed. In one or more example embodiments, the disclosure provides devices, methods and/or systems for image viewing, having one or more of: modular characteristics; telecentric characteristics; lens designs; lens designs in combination with other optical components; an image viewer and headgear as components of a head mounted display; a combination of an image viewer, headgear, and connection technologies as components of a head mounted display, whereby the connection technologies support modular characteristics by enabling detachable connection of one or more expansion components.

### BACKGROUND

The subject matter of this disclosure is directed to devices, methods and systems for image viewing and, more particularly, to such devices, methods and systems having modular characteristics, and to lens designs for such devices, methods and systems.

Image viewing technologies tend to include lenses and combinations of optical components. Toward providing image viewing, such lenses and combinations have been designed and configured in a variety of ways. Using such lenses and combinations, an image may be viewed by optically acquiring the image from the world and transmitting that image optically to the viewer (e.g., via telescopes, microscopes, binoculars, monocular devices, or spectacles). As well, using such lenses and combinations, an image may be viewed by electronically acquiring the image, e.g., using any of various image acquisition devices (examples include still and video cameras employing charge-coupled devices or CMOS imaging chips), which devices may be selected so as acquire images at particular wavelength(s) or ranges of wavelengths (examples include cameras acquiring images either/both in visible wavelengths or/and infrared wavelengths). Moreover, using such lenses and combinations, images may be viewed that are processed, generated, or otherwise provided by computing devices. In the latter two cases, the viewed images may be provided using any of various display devices.

Image viewing technologies are generally employed in association with specific technologies, particularly media-supportive technologies (i.e., those that enable image viewing). However, such specific technologies may encounter constraints associated with the image viewing technologies. As an example, cell phones and portable media players increasingly support features and functionality relating to media, but are constrained by form factor to relatively small displays, which displays tend to inhibit the user's experience. As another example, personal computers (including desktops, laptops and the like) are increasingly powerful and, in that, tend to benefit from ever-more substantial displays; but such displays tend to be realized via physically large devices which, in turn, tends to constrain other advances associated with the computing devices, e.g. in form factor, weight, portability, flexibility, and cost. As yet another example, game stations strive to provide an exciting gaming experience, but delivering that experience often depends on the user's ability to appreciate and exploit virtual space, which ability tends to be constrained by the physical dimensions of a station's associated displays. In still another example, surgical procedures increasingly employ endoscopes and other similar, relatively non-invasive, imaging instruments; however, a surgeon's facility with such instruments tends to be constrained by the display in that the display provides the surgeon's only view into the surgical site.

When such specific technologies encounter constraints associated with image viewing technologies, advances in image viewing technologies generally are urged. Moreover, advances in such specific technologies tend to exacerbate the encountered constraints associated with image viewing technologies, further urging advances in image viewing technologies.

Advances in image viewing technologies may be variously realized. As examples, the advances may be directed to lens design, to combinations of optical components supporting image viewing (e.g., with or without advanced lens design), and/or to systems supporting image viewing (e.g., with or without either of such advanced lens design or of such advanced combinations).

As an example, advances in image viewing technologies may be directed to various systems that are conventionally referred to as head-mounted displays (“HMDs”). HMDs, generally, have been used for various applications. Applications include, as examples, uses in medicine (e.g., for remote viewing of surgical sites), in gaming (e.g., supporting a virtual reality experience) and in military systems (e.g., for flight training, targeting and/or night vision).

HMDs can be immersive or non-immersive. An immersive HMD generally excludes the user's physical environment; that is, the user has no, or insubstantial, visual contact with the user's physical environment (i.e., the user can see or essentially see only the image provided by the HMD). By comparison, a non-immersive HMD generally provides the user with at least some, not-insubstantial visual contact with the user's physical environment. In doing so, a non-immersive HMD tends to enable the user to, e.g., maintain orientation with and obtain visual cues from, their environment (i.e., so as to combat nausea, vertigo or other undesirable, physical reactions). Indeed, a non-immersive HMD may be configured specifically to provide selected visual contact (e.g., with selected physical references and/or in selected directions), including in applications where such visual contact is either preferred or necessary.

HMDs, and other systems supporting image viewing, generally have various, and sometimes competing, design goals. As an example, HMD design goals typically embrace ergonomics, e.g., toward realizing an HMD design that is physically compact, lightweight, convenient, accessible and substantially easy to use. An ergonomic HMD tends: to minimize user fatigue; to facilitate user comfort; to enable the user's natural and proper posture and/or bodily movements; to encourage the user to equip themselves with, and to use, the system; and to enable proper use of the system (e.g., for optimized productivity and other general results).

Existing HMD's tend to fall short as to ergonomics in various ways. As an example, some existing HMDs apply weight or pressure on the user's forehead, ears, and/or bridge of the nose, any of which may be uncomfortable, fatiguing or otherwise undesirable for users.

As another example, an otherwise ergonomic HMD design may fall short in providing preferred or necessary visual contact with the user's physical environment. That is, an HMD design goal may be to provide certain non-immersive parameters, but fall short in doing so due to, e.g., its physical size, layout or other measures of compactness. In the context of surgery, an insufficiently non-immersive HMD may tend to undesirably interfere with a surgeon's necessary vision (central or peripheral), thereby constraining the surgeon's visual contact with other medical professionals, the patient, instruments, monitoring equipment, and/or other persons or things, so as to impede the procedure (e.g., by degrading, slowing or restricting eye-hand coordination, surgical steps or necessary interactions). In a more general context, an insufficiently non-immersive HMD may induce vertigo, nausea or other undesirable physical reactions, associated with excessive isolation from the physical environment.

As another example, an otherwise ergonomic HMD design may fall short due to the coupling mechanism between the HMD and a source of an image. In the case where the image's source is a video camera, for example, existing HMDs tend to be physically tethered to a remotely-located video source, e.g., using a cable therebetween. Such tethering tends to undesirably restrict the user's natural and proper posture and/or bodily movement, including by applying forces/torques to the user at the contact between user and HMD.

As another example, HMD design goals may include appearance. That is, an HMD may designed to be attractive or, at least, not unacceptably unattractive. To illustrate, the HMD may be designed so as to have a reasonably acceptable appearance from the point of view of target users, with or without consideration of the context associated with the particular HMD's use. Appearance may be a design goal, among other reasons, if an HMD that is sufficiently attractive is understood to encourage target users to equip themselves with, and to use, the system.

As another example, HMD design goals generally may strive to deliver against various quality measures relating to optical performance. As an example quality measure, an HMD may be designed so as to provide a specified field of view, e.g., one that is desirable for its application. For desktop computing applications providing images that include text, a field of view of approximately 30 degrees diagonally typically provides sufficient resolution while avoiding eye fatigue related to long-term scanning of larger fields.

As another example quality measure, an HMD may be designed so as to provide an eyepiece (i.e., typically the closest lens or lens group to the eye in image viewing) associated with a specified exit pupil and a specified eye relief. As is known, “exit pupil” refers to a two-dimensional space which has its center at a position along, and is oriented in a plane perpendicular to, the eyepiece's optical axis, and within which the user may place an eye so as to view the image. As is also known, “eye relief” refers to the distance from the vertex of the eyepiece's last optical surface to the location along the eyepiece's optical axis at which the exit pupil is ideally located, e.g., where the exit pupil has the same or approximately the same area as a user's pupil. Generally, the exit pupil should be provided so as to optimize delivery of transmitted light (i.e., the image) to the user's eye and, as well, so as to reduce or avoid shortfalls in image quality (e.g., vignetting). To illustrate, telescopes and binoculars may provide an exit pupil at or over 7 mm in diameter, which size is consistent with the typical user's pupil size at night, whereby (i) at night, where the user's pupil is aligned with the exit pupil, the user's and exit pupils have substantially the same size such that substantially all of the image's light is incident on the retina and (ii) during the day, when images tend to be brighter (i.e., higher light intensity) and cause the typical user's pupil to narrow (e.g., to approximately 4 mm in diameter), the exit pupil may become between two and three times the size of the user's pupil, but without impeding viewing of the image (i.e., the loss of light due to a relatively large exit pupil tends to causes no significant loss in image brightness for the viewer).

As another example quality measure, an HMD may be designed so as to provide an eyepiece associated with a specified eyebox. As is also known, “eyebox” refers to a three-dimensional space (i.e., volume) formed by extending the exit pupil along the optical axis in either direction from the exit pupil's ideal position, and within which space the user can view the image. Relative to the eyebox and to the exit pupil, several characteristics of image quality may depend on the placement of the user's pupil, which characteristics include, as examples: resolution, distortion, and vignetting. Shortfalls as to one or more characteristics of image quality may result in unacceptable image viewing (e.g., such as eyestrain).

As another example quality measure, an HMD may be designed toward accommodating variation of interpupilary distance (IPD) among users. In pursuing this goal, the HMD may be configured to account for all, substantially all, or one or more selected portion(s) of the relatively wide range of IPD in the adult population (e.g., 51 mm for the fifth percentile of females, to 71 mm for the ninety-fifth percentile of males). Some prior art HMDs have sought to account for this range by providing only a fixed, intermediate IPD. However, such HMDs may cause a significant percentage of users to experience discomfort, annoyance and, ultimately, eyestrain.

As another example, HMD design goals may include cost. Cost generally reflects the collective costs of the HMD's bill of materials, including, as examples, the costs of: optical components and/or display devices for acquiring and/or sourcing an image; the lenses and other optical components comprising assemblies that provide image transmission and viewing; the HMD's housing; and the HMD's structures for supporting such lenses, optical components, housing and the like, as well as for providing a stable connection with the user's head. Because an HMD's bill of materials tends to vary by type of HMD, costs generally depend on whether the HMD is binocular, biocular or hybrid.

Some HMDs are binocular. Generally, binocular HMDs are characterized by having two display devices and two optics assemblies. That is, in a binocular HMD, the user views distinct images through both eyes, a first image provided by one display device and a second image provided by the other display device. Using one eye, the user views the first image through one of the two optics assemblies. Using the other eye, the user views the second image through the other of the two optics assemblies. Although the user actually views two distinct images, the binocular HMD generally is constructed so that the user senses a single image, that single image being a brain-formed composite of the two images.

Some HMDs are biocular. Generally, biocular HMDs are characterized by having one display device and a common optics assembly. In a biocular HMD, the user views a single image through both eyes. That is, with both eyes, the user views the single image provided by the one display device, through the common optics assembly, i.e., in a single exit pupil.

Some HMDs are hybrid, having characteristics typical of both binocular and biocular HMDs. In an example hybrid HMD, the user views a single image, the single image being provided by a single display device (i.e., consistent with biocular HMDs), but wherein the image is transmitted to each eye using optical assemblies that are, at least in part, separate (i.e., consistent with binocular HMDs).

In HMDs where the image's source comprises a display device, achievement of cost goals may tend to be determined largely by selection and number of such devices. Display devices typically are the system's most expensive component. As such, by having only one display device, biocular and hybrid HMDs tend to have a price advantage over binocular HMDs. As well, by having only one display device, biocular or hybrid HMDs may have further price advantage because (i) fewer light sources (if any are needed at all) may be employed in association with the display device, (ii) fewer and/or less powerful batteries may be employed to drive the display devices over a unit time, and/or (ii) fewer lenses/other optical components may be employed. By having fewer display devices, light sources, batteries, lenses and the like, the HMD may have less overall weight and/or thermal output and, as such, have further price advantages (e.g., by requiring less expensive housings and/or head mount structures in order to properly resolve engineering criteria).

While achieving cost goals is desirable, HMD generally should strive to achieve such goals without undercutting other design goals. To illustrate, biocular and hybrid HMDs should generally not be implemented so as to secure a price advantage associated with using only one display device, unless the cost goal can be achieved while also achieving one or more quality measures relating to optical performance. Indeed, an HMD design goal may be to achieve both the cost goals and all or selected quality goals, whereby the HMD is configured to deliver substantially equivalent or, preferably, better image viewing than that of more expensive HMD configurations.

### SUMMARY

Most generally, the subject matter of this disclosure provides devices, methods and systems for image viewing.

In one or more example embodiments, the subject matter of this disclosure provides devices, methods and/or systems for image viewing that support modular characteristics.

In one or more example embodiments, the subject matter of this disclosure provides devices, methods and/or systems for image viewing that support telecentric characteristics.

In one or more example embodiments, the subject matter of this disclosure provides lens designs for image viewing.

In one or more example embodiments, the subject matter of this disclosure provides devices, methods and systems for image viewing that employ a lens design disclosed herein.

In one or more example embodiments, the subject matter of this disclosure provides devices, methods and systems for image viewing that employ a lens design disclosed herein so as to support telecentric characteristics.

In one or more example embodiments, the subject matter of this disclosure provides devices, methods and systems for image viewing that employ a lens design disclosed herein, that support telecentric characteristics and/or modular characteristics.

In one or more example embodiments, the subject matter of this disclosure provides an image viewer that employs a lens design disclosed herein.

In one or more example embodiments, the subject matter of this disclosure provides an image viewer that employs a lens design disclosed herein in combination with other optical components.

In one or more example embodiments, the subject matter of this disclosure provides an image viewer that employs a lens design disclosed herein (alone or in combination with other optical components), and supports telecentric characteristics.

In one or more example embodiments, the subject matter of this disclosure provides a head mounted display system comprising an image viewer (that employs a lens design disclosed herein) and headgear.

In one or more example embodiments, the subject matter of this disclosure provides a head mounted display system comprising an image viewer (that employs a lens design disclosed herein) and headgear, the head mounted display system supporting modular characteristics and/or telecentric characteristics.

In one or more example embodiments, the subject matter of this disclosure provides head mounted display system comprising an image viewer, headgear, and a modular assembly, whereby the modular assembly supports modular characteristics by enabling detachable connection of one or more peripherals. In one or more example embodiments, peripherals include, as an example, one or more image sources.

In one or more example embodiments, the subject matter of this disclosure provides a head mounted display system comprising an image viewer, headgear, and a modular assembly, wherein (a) the image viewer includes an image source and (b) the modular assembly supports modular characteristics by enabling detachable connection of one or more peripherals.

The foregoing is not intended to be exhaustive and, moreover, is not an exhaustive summary or list of embodiments and/or features as to the subject matter of this disclosure. Persons of ordinary skill in the art are capable of appreciating other embodiments and/or features, including from the following detailed description, drawings and claims, each alone or in various combinations.

### BRIEF DESCRIPTION OF HTE DRAWINGS

The subject matter of this disclosure is illustrated, by way of example and not by limitation, in the accompanying drawings, in which like reference numerals indicate similar elements and in which:

FIGS. 1A-F show example embodiments of various lens designs.

FIGS. 1A′-E′ show representative, expected performance curves associated with respective lens designs of FIGS. 1A-E.

FIGS. 2A-B show example embodiments of unfolded image viewers.

FIGS. 3A-C show example embodiments of portions of a folded image viewer.

FIGS. 4A-D show example embodiments of a folded image viewer and of various optical components of a display device.

FIGS. 5A-B show an example embodiment supporting adjustment of interpupilary distance.

FIGS. 5A′-B′ show representative, expected performance curves associated with respective adjustment of interpupilary distance in the example embodiment of FIGS. 5A-B.

FIGS. 6A-C show a head mounted display (HMD) system.

FIGS. 7A-B show a head mounted display (HMD) system.

FIGS. 8A-C show a head mounted display (HMD) system employing a video camera.

FIGS. 9A-B show a head mounted display (HMD) system employing a user detection technology.

### DETAILED DESCRIPTION

In this detailed description, certain terminology will be employed so as to disclose the subject matter of this disclosure. It is intended that any and all terminology includes all equivalents. Moreover, unless the disclosure states explicitly otherwise: (i) “includes” means “includes, without limitation”; (ii) terms used in singular form also disclose the plural form, and vice versa; (iii) lists of items (e.g., preceded by “an example”, “examples” and like constructs) are intended to disclose open lists, where other example/items may be added to, implicated by, or otherwise considered to be within the list; and (iv) the term “and/or” may be used in connection with a list of items, in which case it is to be understood that the list discloses “any one of the listed items alone, all of the listed items together, or any combination of two or more of the listed items”.

As used herein, “example embodiment”, “one or more embodiments”, “an embodiment” and/or similar phrases or formulations mean that the components, parts, structures, arrangements, relationships, steps, operations, actions, characteristics, features, functions, numbers, ranges, systems, configurations and/or other details described in connection with that so-referenced embodiment are included in at least one embodiment of the subject matter of the disclosure. Furthermore, one or more, or various combinations, of components, parts, structures, arrangements, relationships, steps, operations, actions, characteristics, features, functions, numbers, ranges, systems, configurations and/or other details may be present in one or more embodiments other than that so-referenced embodiment, and/or may be combined in any suitable manner with one or more embodiments other than that so-referenced embodiment. Moreover, various appearances of any one such phrase or formulation are not necessarily referring to the same embodiment.

As used herein, “image” refers to a representation, in any form, of any object, in whole or in part, which representation is being reproduced, or this is capable of being reproduced. As an example, a reference to “image” may include an optical image that has been optically acquired from the world (e.g., via telescopes, microscopes, binoculars, monocular devices, spectacles or the like). As other examples, any reference to “image” may include an image electronically acquired from the world, in various form(s), including: a single still image; a group of still images; a video clip; a group of video clips; any part of any of these and/or any combination of these. As other examples, any reference to “image” may include an image electronically generated, whether or not acquired, in whole or in part, from the world, in various form(s), including: a single still image; a group of still images; a video clip; a group of video clips; any part of any of these and/or any combination of these. As yet another example, any reference to “image” may include a combination of any of the above examples. Generally, “image” may refer to a representation, in any form, of any object, in whole or in part, that is or may be reproduced so as to enable a user's ultimate perception thereof, e.g., via use of radiation (e.g., visible light) and/or optical components. Any reference to “image” includes both the singular and plural forms, unless otherwise provided by the context.

In the context of an image viewer (as further described hereinafter), an “image” generally is available via the image viewer for viewing by a user. When an “image” is acquired optically, the “image” may be made available to the image viewer via an optical component (e.g., a lens, a mirror, and/or a combination of optical components). When an “image” is acquired or generated electronically, the “image” typically may be made available via a “display device”.

As used herein, “computing device” refers generally to hardware, firmware and/or software resources that execute instructions and/or perform fixed operations (e.g., responsive to events, interrupts or other stimuli), such as to provide a output, task or other result. A computing device may be variously implemented; example implementations may include a microprocessor, a microcontroller, a digital signal processor, a combinational/sequential logic device, a gate array, a computing core or cell, a programmable logic device, and/or a system-on-chip device. A computing device typically includes and/or is coupled to additional components, including, as examples, a memory system, a communication capability, a networking capability and/or input/output resources. Embodiments herein that implicate a computing device may be implemented by embedding the computing device within a greater system. Examples of such systems contemplate that a computing device may be integrated in a chip, module and/or other functional block, possibly along with other functional blocks. In any such system, particular configurations, partitions, groupings and/or other arrangements among blocks are (i) generally neither required nor contemplated and (ii) are all generally within the spirit and scope of the subject matter of this disclosure.

When reference may be made herein to “computing device” as an “image source” (as described below), the computing device may be understood as storing, processing, recovering, generating, reproducing, providing and/or otherwise contributing as to an image, in whole or in part, including an image that can be, or is being, reproduced for viewing by the user. Examples of “computing devices” providing such functionality include: cell phones; portable media players (e.g., the IPOD® of Apple Computer, Inc., Cupertino, Calif.); personal computers (e.g., desktop computers, laptop computers, other computers of any form factor); personal digital assistants (e.g., Palm® devices of Palm, Inc., Sunnyvale, Calif.); storage devices (e.g., LifeDrive™ devices of Palm, Inc., Sunnyvale, Calif.); and/or game stations (e.g., PSP™ and PlayStation® of Sony Computer Entertainment America, San Mateo, Calif.; Game Boy® of Nintendo of America, Inc., Redmond, Wash.; Xbox®, Microsoft Corporation, Redmond, Wash.).

As used herein, “camera” refers to any of various technologies that acquire, or contribute to the acquisition of, all or part of, an image. References to “camera” include, as an example, a component, apparatus and/or system that employs any of various detectors and/or image acquisition devices, e.g., so as to enable an image in the form of an electronic signal (whether the signal is digital or analog). References to “camera” include, as examples, devices that acquire an image at a selected wavelength, at selected wavelengths, in a selected range of wavelengths, and/or in selected ranges of wavelengths (e.g., acquiring images in visible wavelengths and/or infrared wavelengths). References to “camera” include, as examples: endoscopes and other similar, relatively non-invasive, imaging instruments (with or without related computing device) used in surgical procedures; professional and consumer still and video cameras employing charge-coupled devices (CCDs), CMOS imaging chips or other electronic imaging technology (e.g., tube, integrated circuit or otherwise); and/or military, police and emergency cameras employed for pilots, ground troops, police, firemen, rescuers and the like, generally for specialized image viewing (e.g., imaging a target, navigating a plane, spotting hidden combatants or suspects, and/or finding, identifying or assessing victims).

As used herein, “optical source” refers to any of various technologies that source an image, in whole or in part, by optically acquired the image from the world. Examples of an optical source include: telescopes, microscopes, binoculars, monocular devices, and/or spectacles.

As used herein, “image source” refers to any of various technologies that, in whole or in part, source an image. Examples of an image source include: an optical source, a camera and/or a computing device. Examples of an image source also include devices that, directly or indirectly, receive an image, in whole or in part, so as to make the image available to an image viewer (as “image viewer” is described in the disclosure that follows). Image sources may receive images variously, including from, e.g., an optical source, a camera and/or a computing device. Image sources may receive images using various couplings, including, e.g., analog and/or digital technologies; optical, electronic and/or opto-electronic technologies; wired and/or wireless technologies; serial and/or parallel technologies; and/or standards-based and/or proprietary technologies.

As used herein, “display device” refers to any of various technologies that reproduce an image. As an example, a display device reproduces an image for a user's ultimate perception thereof. As examples, the display device may be implemented using, as examples, emissive, transmissive, and/or reflective displays. As further examples, the display device may be implemented using: a liquid crystal display (LCD), whether reflective, transreflective, or transmissive; a liquid crystal on silicon (LCOS) component; a digital micro-mirror device (DMD); and/or other imaging device(s) based on Micro-Electro-Mechanical Systems (MEMS) technology. As yet other examples, the display device may be implemented using light emitting diodes, such as, but not limited to, organic light emitting diodes (OLEDs) (in which examples, the diodes may be provided in a two- and/or three- dimensional array). As still another example, the display device may be implemented using an electrophoretic display.

In an example embodiment, a display device may have integrated therein, specify combination with, and/or otherwise use driver/interface electronics to drive, control and/or otherwise display the image via the display device. Among other implementations, a display device may be implemented separately from its driver/interface electronics, being coupled thereto using various technologies, including, e.g.: analog and/or digital technologies; optical, electronic and/or opto-electronic technologies; wired and/or wireless technologies; serial and/or parallel technologies; and/or standards-based and/or proprietary technologies.

In an example embodiment, a display device may have integrated therein, specify combination with, and/or otherwise use an illumination source. As examples, an illumination source may be used with any of an LCD, an LCOS component, a DMD, MEMS technology and/or an electrophoretic display.

An illumination source may be variously implemented. As examples, an illumination source may be implemented using various light source technologies, including: an incandescent filament; an arc source; one or more laser diodes; and/or one or more LEDs. Generally, as is understood in the art, the selection and/or implementation of the illumination source should be based on, account for, resolve among, and/or otherwise be consistent with relevant factors, including, as examples, the display device (e.g., one or more of technology, dimensions, disposition and/or features of the display device) and/or the application in which the display device is being implemented (e.g., characteristics of the image space, such as f-number relating to the display device and an image plane and/or the color saturation being sought). To illustrate, in an example embodiment wherein a display device supports color imaging via integral color filtering, the illumination source may comprise (i) one or more LEDs, which LEDs may provide “white” light for filtering by the display device or (ii) one or more RGB-LED triads (i.e., wherein each such triad has three LEDs: one emitting red light, one emitting green light and one emitting blue light) so as to further enhance the color saturation of the integral color filtering. To illustrate further, in an example embodiment wherein a display device omits integral color filtering (i.e., but where color imaging is being supported), the illumination source may comprise one or more RGB-LED triads. It is to be understood that, although the description of the illumination source has emphasized various light source technologies, an illumination source may comprise components in addition to any particular light source technology/technologies (e.g., optical components such as one or more lenses, condensers, filters, and/or diffusers).

As to an example embodiment having a display device that uses an illumination source, it should be understood that the illumination source is provided, even if not explicitly described. It should also be understood that the illumination source may be provided either integral with, or separately from, the display device, including being provided in or by a component, module and/or system with which the display device is intended to be used. It should also be understood that the illumination source may be provided as (i) a separate, detachable or replaceable component of an HMD in which the display device is integrated or otherwise used and/or (ii) an integrated component of an HMD with which a display device is or can be associated.

It is also to be understood that a display device and/or an illumination source (if any) may be provided either integrated with or separately from an image viewer, and/or other components, modules, and/or systems associated with the image viewer (as “image viewer” is described in the disclosure that follows). In an illustrative example, a display device and/or an illumination source (if any) may be provided for removable coupling (e.g., on an optical, electronic, electrical and/or mechanical basis) with an image viewer. In another illustrative example, a display device and/or an illumination source (if any) may be provided via permanent coupling (e.g., on an optical, electronic, electrical and/or mechanical basis) with the image viewer. It is understood that a person of ordinary skill in the art may determine any such arrangement based on various relevant factors, including, as an example, the tolerances for optical coupling applicable in any particular application.

It is also to be understood that a display device and/or an illumination source (if any) may be provided either integrated with or separately from an image source. In an illustrative example, a display device and/or an illumination source (if any) may be provided for removable coupling (e.g., on an optical, electronic, electrical and/or mechanical basis) with an image source. In another illustrative example, a display device and/or an illumination source (if any) may be provided via permanent coupling (e.g., on an optical, electronic, electrical and/or mechanical basis) with the image source. It is understood that a person of ordinary skill in the art may determine any such arrangement based on various relevant factors, including, as an example, the tolerances for optical coupling applicable in any particular application.

In an example embodiment, the display device is a microdisplay device. An example of a light emissive microdisplay device is the SVGA+ of eMagin Corporation of Hopewell Junction, N.Y. An example of an electroluminescent microdisplay device is the MicroBrite AMEL640.480, of Planar America, Inc. of Beaverton, Oreg. An example of a diffusely backlit transmissive microdisplay device is the KCD-KDCF-AA of Kopin Corporation of Taunton, Mass. An example of an SVGA reflective LCOS display is Z86D-3 of Brillian Corporation, Tempe, Ariz.

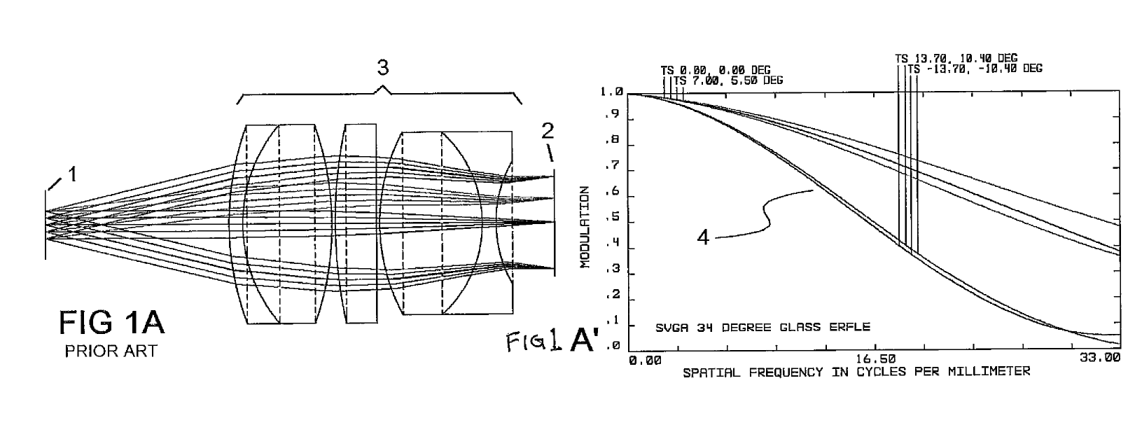

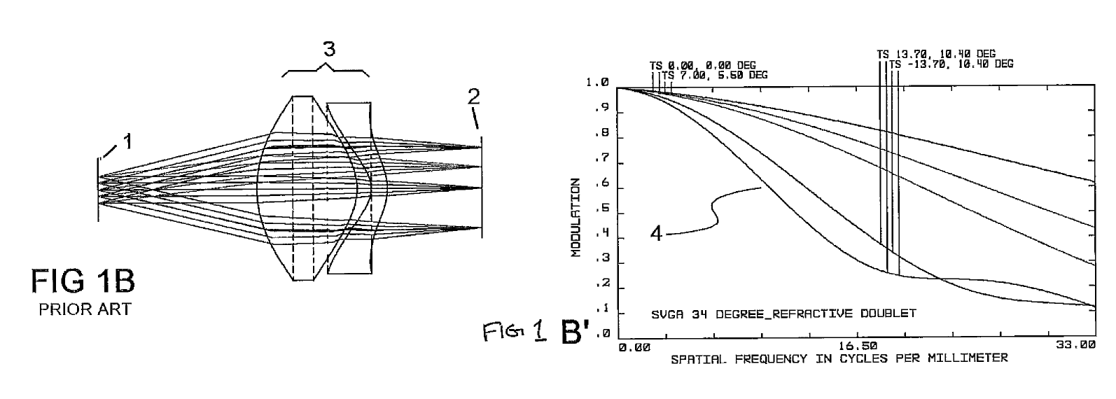

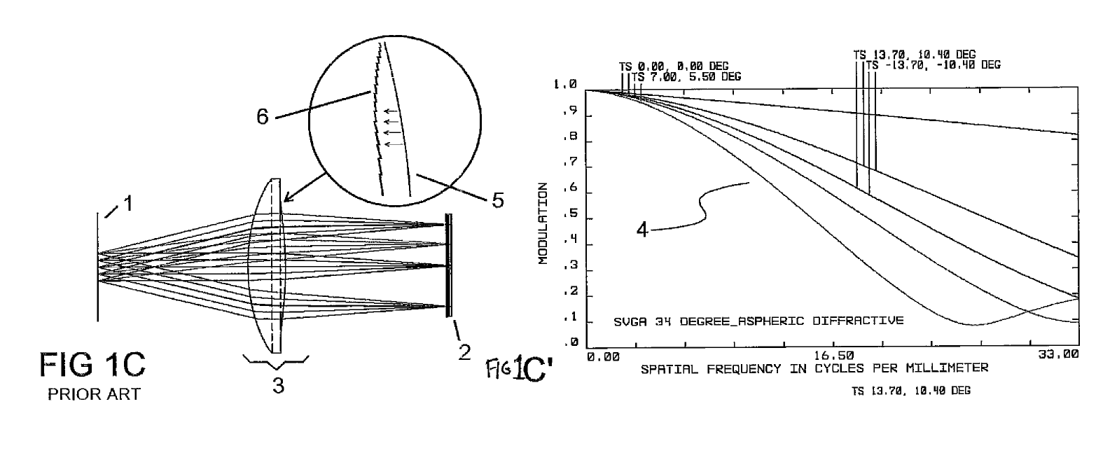

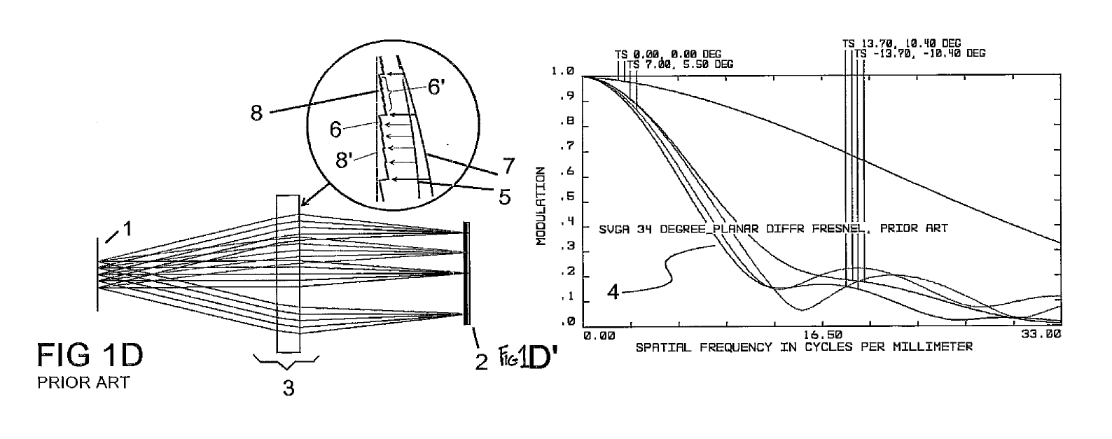

FIGS. 1A-E show various lens designs. These lens designs illustrate various lens structures 3. In each of FIGS. 1A-E, the solid lines represent the profile of the lens structure in a center cross-section, while the lens structure's edges are represented in dashed lines.

Each of FIGS. 1A-E show a lens design having an exit pupil 1, a display 2 and a lens structure 3. As illustrated, then, each lens design conveys that, at the exit pupil 1, a user's pupil may be disposed for viewing an image from the display 2 through the respective lens structure 3. In an example embodiment, a lens design may be modeled so that the exit pupil 1 is as wide as would be consistent with the respective lens design. Similarly, in an example embodiment, a lens design may be modeled so that as much eye relief is provided as would be consistent with the respective lens design. In an example embodiment, a lens design may be implemented in an achromatic eyepiece, configured to form a 34-degree diagonal virtual image of an SVGA microdisplay having 800 pixels horizontal×600 pixels vertical and a 15 mm diagonal.

FIGS. 1A′-E′ show representative, expected performance curves 4 associated with respective lens designs of FIGS. 1A-E. These performance curves 4 are modulation transfer function curves (MTF curves) wherein: (a) MTF curves convey spatial frequency response for various points in the field of view, from the center field to the diagonal extremes of the display and (b) generally flatter, higher level responses correlate to higher performing lens designs. So as to illustrate expected performance comparisons among lens designs consistent with FIGS. 1A-E, the MTF curves 4 of FIGS. 1A′-E′ show spatial frequency responses for selected sets of tangential (T) and sagittal (S) coordinates, the sets being presented as to each of the five lens designs. Further toward enabling a reasonable comparison among the lens designs of FIGS. 1A-E, the MTF curves 4 of FIGS. 1A′-E′ show representative, expected spatial frequency responses in relation to lenses modeled for use with the above-described SVGA microdisplay, as indicated by plotting spatial frequency from 0 up to of 33 cycles per millimeter (this range follows from the Nyquist frequency of the above-described SVGA microdisplay, with 2 pixels equaling one cycle, i.e., 800 pixels/(2×12 mm)=33 cycles/mm). Still further toward enabling a reasonable comparison among the lens designs of FIGS. 1A-E, the representative, expected MTF curves 4 are associated with lens designs of FIGS. 1A-E as would be modeled for use in the same application, e.g., a head mounted display (HMD).

FIG. 1A shows a lens design comprising five spherical, glass elements arranged as two cemented doublets on either side of a singlet. This lens design is generally consistent with a so-called Erfle eyepiece. While Erfle eyepieces commonly are used in microscopes, the lens design of FIG. 1A is modeled for use in a HMD. Accordingly, the lens design has been modeled so as to have (i) eye relief that is longer than would be typical for a microscope and (ii) an exit pupil that is larger than would be typical for a microscope. So modeled, this lens design's performance may be reasonably compared with the other lens designs of FIGS. 1A-E.

FIG. 1B shows another prior art lens design. This lens design comprises a refractive doublet with all aspheric surfaces, using a low-index polymer for the positive lens and a high-index polymer for the negative lens so as to achieve moderate chromatic correction. This lens design appears to be less bulky than that of FIG. 1A. However, this design's positive lens has a relatively thick positive element, which characteristic may be significant for a polymer injection-molding manufacturing process.

FIG. 1C shows a lens design comprising a dual-aspheric singlet with a diffractive structure on one surface so as to provide chromatic correction. This lens design's diffractive structure is understood to be consistent with a so-called “kinoform”, the definition, design and use of which is well understood by persons of ordinary skill in the art. For an achromatic design, the diffractive chromatic dispersion is modeled to be approximately equal and opposite the refractive chromatic dispersion of the bulk of the lens.

The balloon of FIG. 1C shows a partial cross-section of the diffractive structure. The diffractive structure has diffractive steps 6, the diffractive steps 6 being of variable pitch and constant depth. The diffractive structure—via these diffractive steps—should be optically equivalent to or substantially equivalent to a phase profile (represented by curve 5), which phase profile should be determined for chromatic correction in the context of the lens design. That is, the diffractive structure represents a collapsed phase profile, wherein the depth of the structure's steps may determine the peak diffraction efficiency for a given center wavelength of the spectrum of interest and for a given index of refraction of the lens material. In an example implementation for the visible spectrum using an acrylic lens material, the depth of the structure's steps may be on the order of one micron. In any example implementation (i.e., determined by design parameters, including known lens materials and/or the spectrum of interest), the design process for obtaining a diffractive structure is well understood by persons of ordinary skill in the art.

FIG. 1D shows a lens design comprising a singlet having a base profile comprising two planar surfaces and having both diffractive and Fresnel structures. Generally, the lens design provides for chromatic compensation. As shown, the diffractive and Fresnel structures are combined on one of the two surfaces so as to form a diffractive/Fresnel structure 8 thereon. However, it is understood that: (i) a diffractive/Fresnel structure 8 may be formed on either of the two surfaces; (ii) the diffractive structure may be formed on one surface while the Fresnel structure is formed on the opposite surface; and (iii) the Fresnel and diffractive structures can be formed either to extend into or protrude out of their respective surface or surfaces. In an example embodiment (i.e., determined by design parameters, including known lens materials and/or the spectrum of interest), the design process for obtaining each and any of a diffractive structure, Fresnel structure, and/or diffractive/Fresnel structure are well understood by persons of ordinary skill in the art.

The balloon of FIG. 1D shows a partial cross-section of the diffractive/Fresnel structure 8. In the diffractive/Fresnel structure 8, the diffractive structure has diffractive steps 6. In this embodiment, the diffractive steps 6 have variable pitch and constant depth wherein, generally, a constant depth tends to optimize the diffractive chromatic correction, i.e., at a given center wavelength. The diffractive structure—via these diffractive steps—should be modeled so as to be optically equivalent to or substantially equivalent to a first phase profile (represented by curve 5). That is, the diffractive structure should represent a collapsed first phase profile, wherein the depth of the surface's steps determines the peak diffraction efficiency for a given center wavelength of the spectrum of interest and for a given index of refraction of the lens material. As such, at the given center wavelength, diffraction is maximized for first-order diffraction and minimized for higher—order diffraction—occurring at diffraction angles other than desired (which manifests itself as scattered light). To either side of the given center wavelength, first-order efficiency decreases and higher orders begin to gain strength (e.g., deep blues and reds may exhibit a bit of blue or red haze).

Similarly, in the diffractive/Fresnel structure 8, the Fresnel structure has Fresnel steps 6′. In this embodiment, the Fresnel steps 6′ have variable pitch and variable depth. It is understood, however, that the Fresnel structure can have pitch and/or depth variable (e.g., either pitch or depth may be constant, while the other is variable). It is also expected that constant depth tends to keep a design relatively closely constrained to the base profile.

The Fresnel structure—via Fresnel steps—should be modeled so as to be optically equivalent to or substantially equivalent to a second profile (represented by curve 7). That is, the Fresnel structure should represent a collapsed second (sag) profile. It is understood that the Fresnel pitch should be substantially greater than the diffractive pitch so as not to degrade the diffractive efficiency (e.g., about 20 or more diffractive steps in each Fresnel facet).

In the balloon of FIG. 1D, as indicated by reference line 8′, the diffractive/Fresnel structure 8 is shown to have a planar or substantially planar characteristic. That is, the diffractive/Fresnel structure conforms to lens design's planar surface, i.e., the surface on which the diffractive/Fresnel structure is formed. It is understood that, where the diffractive structure is provided separately from the Fresnel structure, each of the diffractive structure and the Fresnel structure have a planar or substantially planar characteristic; that is, each such structure conforms respectively to the lens design's planar surface on which they are formed.

While a lens design consistent with FIG. 1D may have application in connection with image projection (e.g., in a rear projection television screen as an intensity concentrating field lens), the particular lens design of FIG. 1D is modeled for use in a HMD (e.g., as a high-quality imaging lens) in order to enable reasonable comparison of the lens design's performance with the other lens designs of FIGS. 1A-C and 1E (as previously described, each of the lens designs is modeled for use in an HMD for comparison purposes). In such HMD application, it is understood that uncorrected aberrations relating to the planar structure may tend to impede performance, e.g., degrade image quality).

Turning to FIG. 1E, a lens design is shown that comprises a singlet having aspheric surfaces. On one aspheric surface, the lens design comprises a Fresnel/diffractive structure 10. Opposite that structure, the lens design comprises a smooth or substantially smooth aspheric surface. Generally, such a smooth aspheric surface—in an embodiment having it disposed toward the exit pupil—tends to be useful in a relatively lens-incompatible environment (e.g., an external, working environment). In example embodiments, the cross-sectional shape of the singlet's surfaces should respond to the specific application for the embodiment. In an example embodiment relating to an HMD system consistent with the disclosures hereof, both surfaces may be aspheric as shown in FIG. 1E. In an example embodiment for another application, the embodiment may have a spherical surface.

The balloon of FIG. 1E shows a partial cross-section of the diffractive/Fresnel structure 10. In the diffractive/Fresnel structure 10, the diffractive structure has diffractive steps 6. In this embodiment, the diffractive steps 6 have variable pitch and constant depth. Generally, the diffractive steps should be constant depth or substantially constant depth, so as to control visible scatter, e.g., in the deep reds and blues. The diffractive structure—via such diffractive steps—should be modeled to be optically equivalent to or substantially equivalent to a first phase profile (represented by curve 5). That is, the diffractive structure should represent a collapsed first phase profile, wherein the depth of the surface's steps determines the peak diffraction efficiency for a given center wavelength of the spectrum of interest and for a given index of refraction of the lens material.

Similarly, in the diffractive/Fresnel structure 10, the Fresnel structure has Fresnel steps 6′. In this embodiment, the Fresnel steps 6′ have variable pitch and/or variable depth. The Fresnel structure should be modeled to be optically equivalent to or substantially equivalent to a second profile (represented by curve 7). That is, the Fresnel structure should represent a collapsed second (sag) profile. In an example embodiment, the Fresnel structure generally should be implemented to support approximately 20 or more diffractive steps per Fresnel zone. In an example embodiment, the Fresnel steps can vary. In an example embodiment having varying Fresnel steps, the steps should vary while adhering to the base profile sufficiently to preclude localized defocus.

In the balloon of FIG. 1E, as indicated by reference line 9, the cross-section of the diffractive/Fresnel structure 10 is shown to have a curved or otherwise substantially non-planar characteristic. In example embodiments, the cross-sectional shape of the diffractive/Fresnel structure should respond to the specific application for the embodiment. In an example embodiment, the cross-section of the diffractive/Fresnel structure 10 may be modeled/implemented to conform to the lens design's aspheric surface on which the diffractive/Fresnel structure 10 is formed.

In an example embodiment, the Fresnel structure may be modeled/implemented to include 20 or more diffractive zones within each Fresnel zone (e.g., so as not to diminish the diffraction efficiency and while maintaining a high-quality Fresnel structure), wherein a diffractive zone is the optical surface intermediate to the diffractive steps and a Fresnel zone is the optical surface intermediate to the Fresnel steps. In an example embodiment, the radial width of a Fresnel zone may be determined by the localized sag as set forth by the spheric/aspheric equations and the depth of the step (e.g., the sag over the width of the zone equals the depth of the step).

The lens design of FIG. 1E is expected generally to enable relatively compact and lightweight implementation. Moreover, this lens design is expected generally to enable a relatively thin profile and relatively slight shape variation, each of which characteristics is understood to improve manufacturing economies where the lens is made using plastic molding (e.g., reduced machine time in injection molding). Moreover, it is expected that, in example embodiments, the shape of the lens' surfaces may be carefully maintained, particularly in a high performance design (e.g., typically to a few fringes per cm), when manufacturing using a molding process. That is, where an embodiment is manufactured using an injection molding process, it is expected that, due to the lens' relatively thin sections and minimal cross-section variation, (i) the shape of the lens' surfaces should be maintained, (e.g., avoiding sink, that is, distortion of the desired surface shape), (ii) manufacturing costs should be lesser than those of other lens' (e.g., those other lens' being relatively thick lenses and/or having significant cross-section variation) in that molding may be achieved with shorter cycle times, and (iii) quality control will be enhanced.

As well, this lens design may be useful in field applications, including those applications wherein diffractive and/or Fresnel surfaces may be incompatible with a working environment (e.g., in an example embodiment wherein its smooth aspheric surface is exposed to a work environment (i.e., disposed toward the exit pupil), this lens design will have no exposed diffraction or Fresnel structures, which structures are understood to be relatively delicate and/or readily contaminated such as, e.g., by particulates, dust, moisture, oils and/or other environmental contaminants).

Referring to FIGS. 1A′-E′, representative, expected MTF curves 4 are shown, respectively, for lens designs consistent with FIGS. 1A-E. Of these curves, the MTF curves 4 of FIG. 1E′ are substantially flatter, while generally maintaining a higher level, across the indicated spatial frequency range. Generally, the MTF curves of FIG. 1E′ suggest that a lens design consistent with that of FIG. 1E can enable superior performance in certain applications. As an example, embodiments of this lens design are expected to have facility for applications wherein the lens design is deployed for viewing images of a microdisplay (e.g., in certain HMDs, as in the comparison of the MTF curves). Example embodiments of this lens design are also expected to have facility for applications wherein the lens design is deployed in a camera toward acquiring an image, e.g., whether the image is acquired using radiation in the visible spectrum, or is acquired using radiation in the infrared spectrum, or otherwise. To illustrate, with certain thin-section polymers (e.g., high-density polyethylene formulations), the lens design is expected to have facility for imaging applications in the thermal infrared spectrum, such as, as an example, as a lens in a camera using a microbolometer imaging array and being responsive to wavelengths in, e.g., the 8 to 12 micrometer range.

Turning to FIG. 1F, an example embodiment is shown of a lens design/implementation consistent with FIGS. 1E, 1E′. In this FIG. 1F, the lens comprises: a surface A that has smooth, first non-planar profile (e.g., spherical or aspheric); a surface B being a base second non-planar profile (e.g., spherical or aspheric); and a center thickness C (e.g., generally minimized by Fresnel power). In the balloon of FIG. 1F, a section is shown that greatly magnifies the depth profile, including greatly magnifying the Fresnel zone D, diffractive zone E, and Fresnel step F. In an example embodiment consistent with the MTF curves of FIG. 1E′ (e.g., for imaging relating to the described microdisplay), the lens is formed using optically clear material (e.g., polysulfone), has a rectangular profile (e.g., 12 mm×15 mm) and a relatively thin center thickness (e.g., 2.5 mm), wherein (i) the first profile has a smooth, 16th order aspheric sag and (ii) the base second profile has a 16th order aspheric sag, a superimposed Fresnel (e.g., 16th order aspheric sag, variable step and pitch; step every 20 diffractive zones) and a superimposed diffractive (e.g., 6th order phase, fixed step (0.86 micron) with variable pitch). It is contemplated that an example embodiment consistent with FIGS. 1E, 1E′ and/or 1F may be designed and implemented as either/both the illumination lens and/or the relay lenses of an HMD system consistent with the subject matter of this disclosure (as each such lens is described hereinafter).

It is to be understood that a lens design may have certain performance characteristics that may be less than ideal. In such case, the performance shortfall may be variously addressed. To illustrate, the performance characteristics may be adjusted using various optical techniques, including, as examples, by using various films, dyes, and/or other treatments in association with one or more elements, and/or surface(s) thereof. It is noted that use of dyes to address variation in relative illumination across an aspheric lens is disclosed in Hebert, U.S. Pat. No. 6,972,735, Patent Date Dec. 6, 2005, which disclosures, as well as all other disclosures thereof, are hereby incorporated by reference, as if set forth herein in its entirety, for all purposes. Also to illustrate, the performance characteristics may be addressed by combining lens structures. It is noted that combining lens structures is disclosed in Hebert, U.S. Pat. No. 6,008,939, Patent Date Dec. 28, 1999, which disclosures, as well as all other disclosures thereof, are hereby incorporated by reference, as if set forth herein in its entirety, for all purposes.

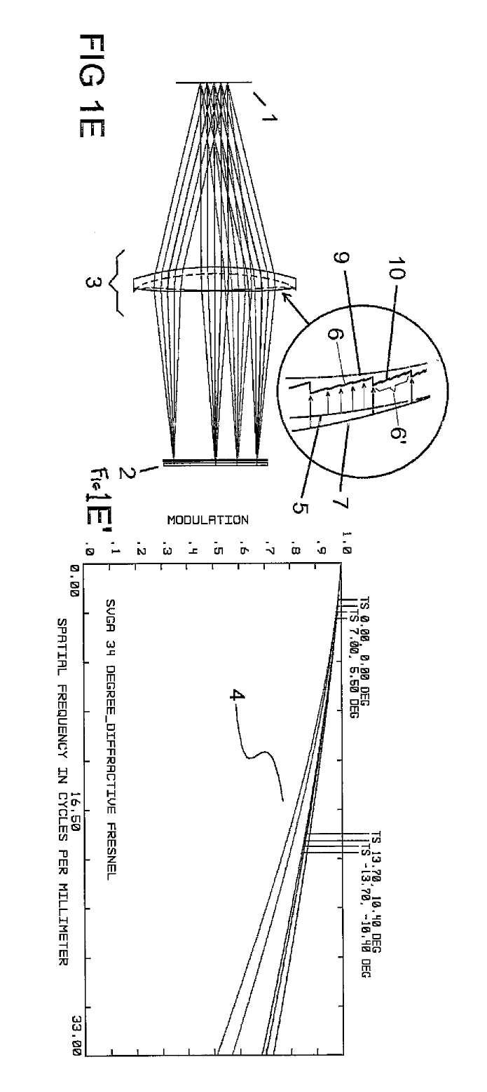

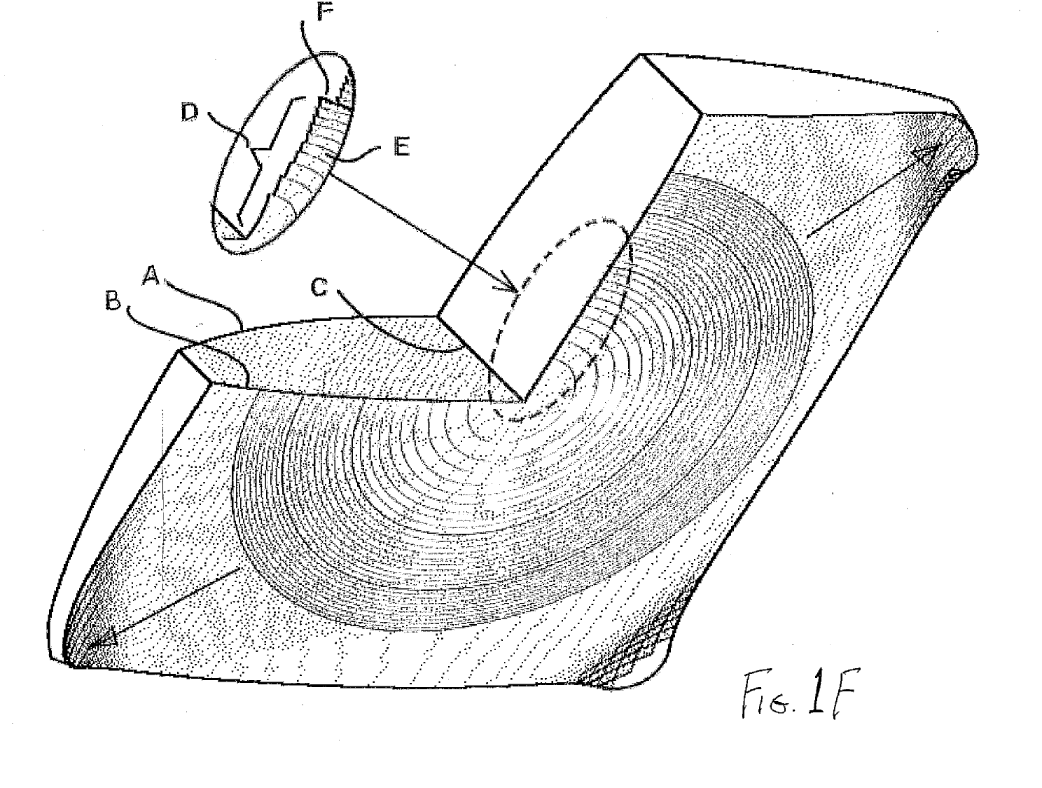

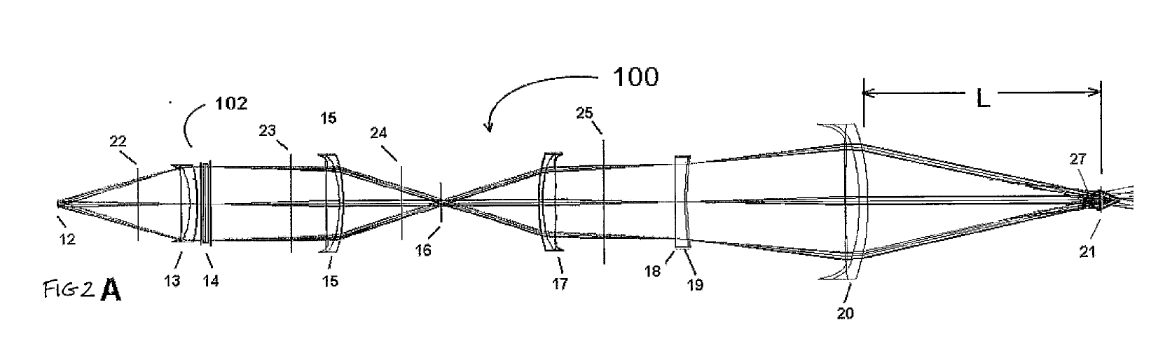

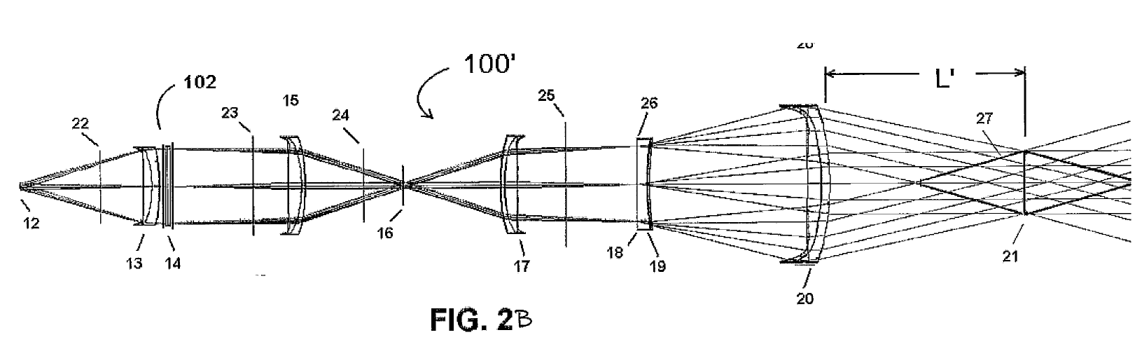

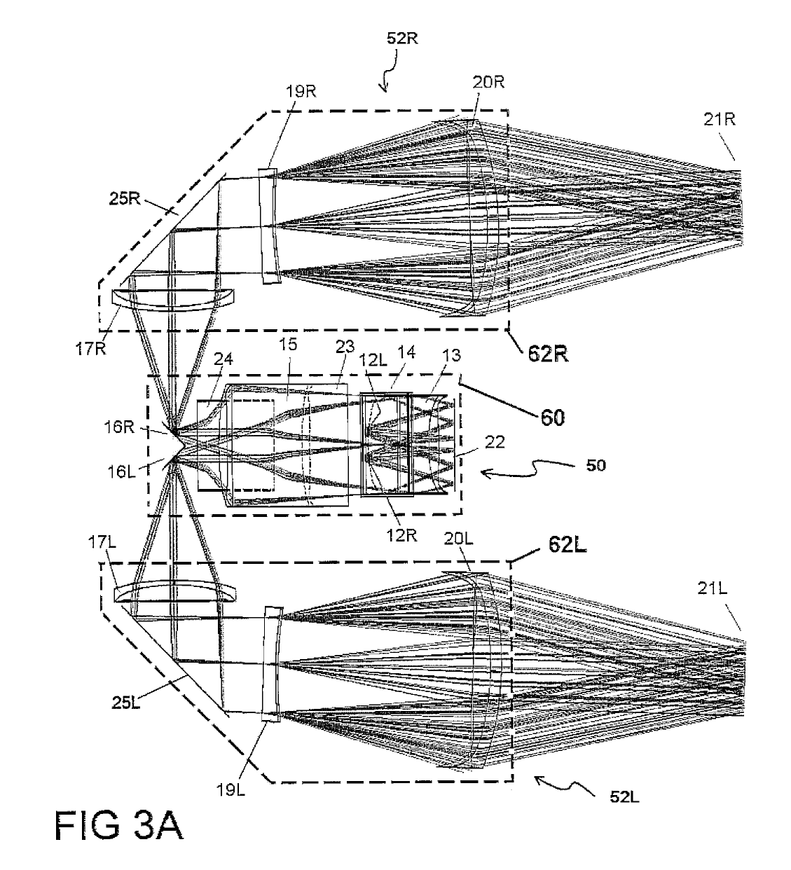

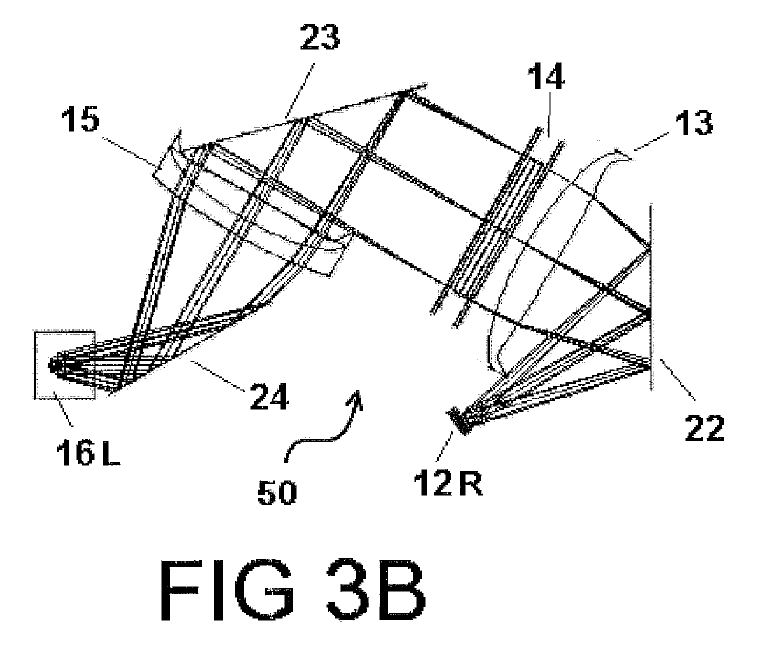

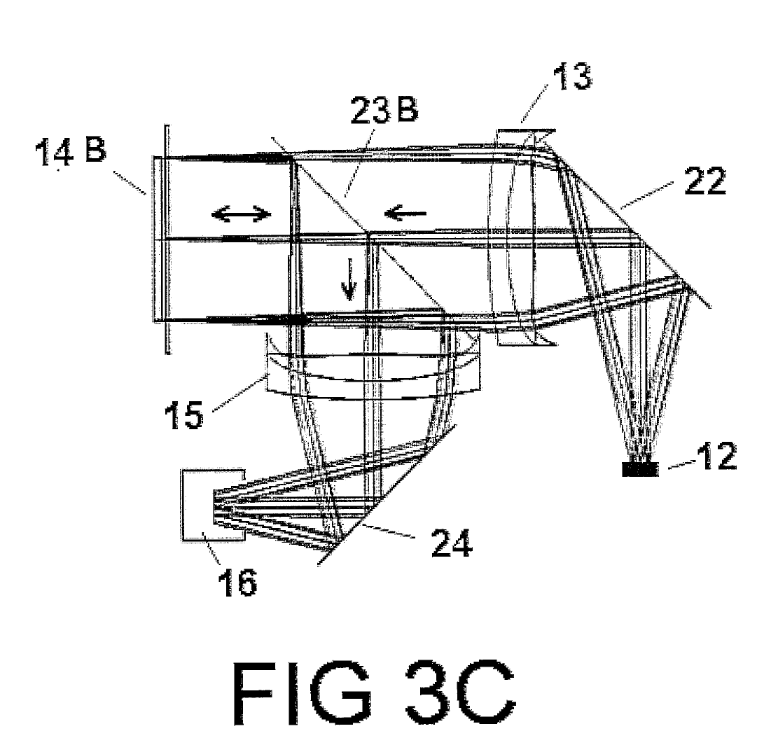

As to FIGS. 2A, 2B, 3A, 3C, example embodiments of an image viewer are shown that employ various optical components. FIGS. 2A, 2B show example embodiments of an image viewer that employ various optical components. In FIGS. 2A, 2B, the image viewer is not folded, although various folding planes are indicated. FIGS. 3A, 3B show an example embodiment of an image viewer that employs various optical components, the image viewer being folded at various folding planes. Assuming all aspects of the example embodiment of FIG. 2A are equivalent to counterpart aspects of the example embodiment of FIGS. 3A, 3B, and assuming further that the image viewer is comprised in a head mounted display (HMD), FIG. 2A may be understood to show each unfolded single-eye channel of the HMD, including the folding planes that obtain the folded image viewer of a HMD as shown in FIGS. 3A, 3B. Similarly, assuming all aspects of the example embodiment of FIG. 2B are equivalent to counterpart aspects of the example embodiment of FIGS. 3A, 3B, and assuming further that the image viewer is comprised in a HMD, FIG. 2B may be understood to show each unfolded single-eye channel of the HMD, including the folding planes that obtain the folded image viewer of a HMD as shown in FIGS. 3A, 3B. Moreover, the example embodiments of FIGS. 2A, 2B may be employed in a hybrid HMD, a biocular HMD or a binocular HMD.

Turning to FIG. 2A, an example embodiment of an image viewer 100 comprises a first relay lens 15, nominal stop plane 16, second relay lens 17, intermediate image plane 18, field lens 19, and eyepiece 20. The example embodiment of image viewer 100 is characterized by an exit pupil 21 and an eye box 27.

In FIG. 2A, the example embodiment of image viewer 100 is shown with general locations of various folding planes. In this example embodiment, one or more of the folding planes may be implemented using mirrors. To illustrate, the example embodiment of image viewer 100 comprises splitting mirror 16′, display mirror 23, rotational mirror 24, and field mirror 25. Each such mirror propagates light (e.g., all or part of an image) via reflection.

In FIG. 2B, the example embodiment of an image viewer 100′ comprises and indicates (a) the optical components and folding planes of the example embodiment of the image viewer 100 of FIGS. 2A and (b) a diffuser 26. As is described further below, the diffuser generally is implemented, or not, so as to provide a selected eye box and/or selected an exit pupil (e.g., an eyebox of selected volume and/or an exit pupil of selected area). In an example embodiment, the diffuser 26 contributes to both eye box and exit pupil, while eye relief is formed by a combination of the degree of diffusion, the optical power of the field lens 19 and the angle of incidence onto the diffuser's diffusing surface. The example embodiment of image viewer 100′ is characterized by an exit pupil 21′ and an eye box 27′.

In both FIGS. 2A and 2B, an example embodiment of a display device 102 is shown. In this example embodiment, the display device 102 comprises a display unit 14, an illumination source 12, an illumination lens 13 and an illumination mirror 22. In FIGS. 2A, 2B, the light output from the illumination source 12 is collimated or substantially collimated by illumination lens 13. As is described further below, in an example embodiment of an HMD application having telecentric characteristics, the lens 13 provides collimated light, generally in support of a collimated image space between relay lenses 15, 17. The illumination mirror 22, as shown in FIGS. 3, may be employed for folding purposes.

The display unit 14 may be variously implemented, including (i) as shown in FIGS. 2, using a transmissive LCD microdisplay (as previous described), (ii) using a reflective microdisplay (e.g., based on LCOS or LCD technologies, as those technologies are previously described), or (iii) using other display technologies (as those technologies are previously described or otherwise). That is, it is to be understood that, although a transmissive technology is shown in FIGS. 2A, 2B for display unit 14, other technologies may be implemented (whether including, excluding or without any illumination source). In an HMD application, it is also understood that the particular display unit 14 should be selected and implemented responsive to, and/or toward resolving among, applicable engineering criteria (e.g., the field application to which the HMD system is being designed, the display's pixel number, the f-number of the display's pixels, and/or the angle of light emission/transmission/reflection). It is further understood that display technology (e.g., as applied in microdisplays) is advancing continually and, with that, there is an expanding universe of available display technologies and microdisplays using any such technologies.

In example embodiments, the illumination source 12 may also be variously implemented. Generally, the illumination source 12 should be implemented consistent with the display device 102 and the application. As such, with some display devices, no illumination source 12 may be employed.

In example embodiments, the illumination lens 13 and/or the illumination mirror 22 may be variously implemented. Generally, these components are implemented, if provided at all, based on, responsive to and/or toward resolving among, various factors, including, as examples: (a) the application; (b) the type of display device 14; (c) the relative dimensions of the illumination source 12 and/or the display unit 14; and/or (d) the available dimensions for proper illumination of the display unit 14.

As shown, illumination lens 13 may be modeled and/or implemented consistent with the lens design of FIG. 1E (as described above). It is to be understood that illumination lens 13 may be modeled and/or implemented using other lens designs. As previously described, the illumination lens 13 may be modeled and/or implemented consistent with the application in which the lens is employed. To illustrate, in an example embodiment where the illumination lens 13 is employed in an image viewer comprised in a HMD, the illumination lens 13 may be modeled using a lens design so as to respond to relevant design criteria, including, as examples, compactness (e.g., small), weight (e.g., light), economy (e.g., relatively inexpensive) and/or optical performance (e.g., achromatic quality, proper transmission of relevant wavelengths). Also to illustrate, in an example embodiment where the illumination lens 13 is employed in an image viewer comprised in a HMD having telecentric characteristics consistent with the subject matter of this disclosure, it is recognized that modeling the illumination lens 13 using the lens design of FIG. 1E will tend to provide advantages, e.g., as to the above criteria generally, as well as specifically as to the quality of the HMD's telecentric characteristics (i.e., which generally may be associated with the illumination lens' performance in collimating light). It is expected that, in an example embodiment of an HMD having telecentric characteristics, the illumination lens may imperfectly collimate light across the field of the display and, in that case, the result may be some localized departure from absolute telecentricity and/or some defocus of the source at the telecentric stop. However, relay lens design is expected to be designed/implemented so as to enable the HMD's proper performance, including by accommodating shortfall in the illumination lens' collimation (e.g., toward minimizing MTF degradation).

It is also understood that the image made available to the image viewer generally will relate to the image source associated with the image viewer, which, in turn, may depend on the image viewer's application. As an example, if an image viewer is comprised in an HMD, the image source may be a camera, in which case the image may be made available by a display device. However, as another example, if an image viewer is comprised in a modular HMD consistent with the subject matter of this disclosure, the image source may be user-selectable (e.g., a telescope, a camera, and/or a computing device) and, depending on the selected image source at any given time, the image may be made available by an optical component and/or a display device.

In FIGS. 2A, 2B, the light from illumination source 12, as collimated by illumination lens 13, is shown passing through the display unit 14 (e.g., in FIGS. 2, shown as a transmissive microdisplay). More specifically, the light is shown as three cones from the illumination source 12 which light is collimated or substantially collimated (within the physical limitations of the finite size of the source and the focal length of the illumination lens 13) and, so collimated, is apertured through pixels of the display's plane (not shown) in the display's top, bottom and center. It is understood that the three cones of light are for illustration purposes, i.e., to convey propagation of light (e.g., transmission, reflection and/or ultimate delivery of light to the user) through the image viewer to the exit pupil 21/eyebox 27. Additional cones of light could have been shown for any or all pixels (e.g., at midfield points, such as in the display's top/center and/or bottom/center). However, additional cones of light have been omitted so as to provide a less cluttered illustration and, thus, to improve clarity of the disclosure.

In propagating through the display unit 14, the light from the illumination source 12 generally is modulated, pixel-by-pixel, according to image data (e.g., as to a still image or a video clip) provided to the display (e.g., by, from and/or in an image source, such as a camera or computing device).

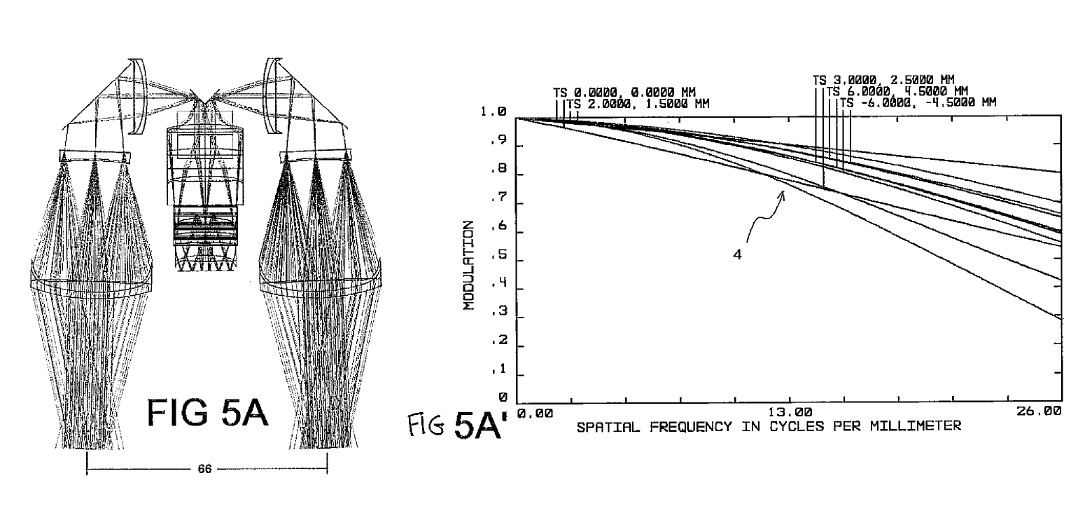

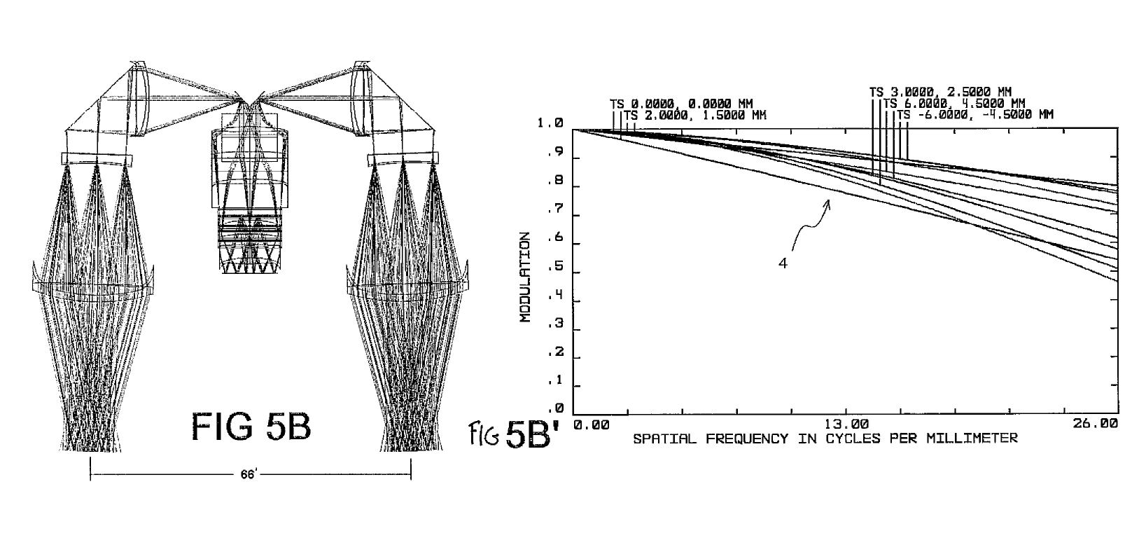

The light is propagated from the display unit 14 to and through the first relay lens 15. In an example embodiment where the first relay lens 15 is employed in an image viewer comprised in a HMD having telecentric characteristics consistent with the subject matter of this disclosure, the first relay lens 15 may be designed such that each pixel cone of light is precisely collimated (i.e., collimated sufficiently precisely so as to enable adjustment of interpupilary distance (IPD) across a selected range). In such example embodiment (as will be described further hereinafter), precise collimation may enable variation in the distance between first relay lens 15 and second relay lens 17, while incurring minimal impact on image quality for the user (i.e., while maintaining optical performance within an acceptable range, which is illustrated in the MTF curves 4 of FIG. 5). Such variation may be user-selected (i.e., in connection with IPD adjustment) and/or may be associated with substantial accommodation of manufacturing tolerances.

In an example embodiment of such an HMD wherein the light from the illumination source 12 were not collimated or not well collimated by the illumination lens 13, first relay lens 15 may be designed and implemented so that sufficient light collimation is established in the space between the first relay lens 15 and the second relay lens 17 and, as such, telecentricity is established (e.g., so that IPD adjustment may be supported, as described below). In such case, it is understood that the light cones are collimated for plural portions of the image (e.g., individual pixels of the image provide via the display device 102), even though the cones generally may not be actually parallel to the optical axis of the image viewer 100 (i.e., cones associated with pixels not on and/or wholly aligned with the optical axis). That is, it is understood that a ray bundle from any single point on the plane of the display is substantially collimated, within itself, between the relay lenses, even though those rays are only parallel to the optical axis for the central point on the display.

As shown in FIGS. 2A, 2B, first relay lens 15 may be modeled and/or implemented consistent with the lens design of FIG. 1E (as described above). Also as shown, second relay lens 17 and/or eyepiece 20 may be modeled and/or implemented consistent with the lens design of FIG. 1E (as described above). It is to be understood that any one, any combination, or all of lens 15, lens 17 and/or eyepiece 20 may be modeled and/or implemented using other lens designs. Generally, any such optical component 15, 17, 20 may be modeled and/or implemented consistent with the application in which the lens is employed. To illustrate, in an example embodiment where any such optical component is employed in an image viewer comprised in a HMD, any such optical component 15, 17, 20 may be modeled using a selected lens design so as to respond to relevant design criteria, including, as examples, compactness (e.g., small), weight (e.g., light), economy (e.g., relatively inexpensive) and/or optical performance (e.g., achromatic quality, proper transmission of relevant wavelengths, minimal distortion sufficient MTF response, etc.). Also to illustrate, in an example embodiment where any such optical component 15, 17, 20 is employed in an image viewer comprised in a HMD having telecentric characteristics consistent with the subject matter of this disclosure, it is recognized that modeling any such optical component 15, 17, 20 using the lens design of FIG. 1E will tend to provide advantages, e.g., as to the above criteria generally, as well as specifically as to the quality of the HMD's telecentric characteristics.

Conversely, in an HMD supporting telecentric characteristics, it is recognized that modeling any such optical component 15, 17, 20 using a lens design providing compromised performance (e.g., characterized by MTF curves 4 inferior to those of a lens design modeled consistent with FIG. 1E) will tend to provide disadvantages, including, e.g., as to the above criteria generally, as well as specifically as to the quality of the HMD's telecentric characteristics. Generally, overall performance of the HMD tends to be degraded if any such optical component 15, 17, 20, as modeled/implemented, compromises any of the relevant criteria. Indeed, it is expected that, in such HMD application, compromises introduced by any one such optical component 15, 17, 20 will tend to be exacerbated as the image is propagated through the image viewer.

To illustrate, in an HMD having telecentric characteristics (e.g., supporting an adjustment range of interpupilary distance (IPD)), telecentric performance of the HMD tends to be degraded if the first relay lens 15, as modeled/implemented, introduces compromises relating to its optical coupling with the illumination lens 13, including, e.g., compromises that degrade light collimation.

Also to illustrate, in an HMD having telecentric characteristics (e.g., supporting an adjustment range of interpupilary distance (IPD)), telecentric performance of the HMD tends to be degraded if the second relay lens 17, as modeled/implemented, introduces compromises relating to its optical coupling with the first relay lens 15. Second relay lens 17 generally de-collimates light rays in forming an intermediate image (as that operation is further described herein). However, the light rays of the intermediate image maintain the HMD's telecentric characteristics provided the spacing of lens 17 from the HMD's telecentric stop matches the focal length of lens 17. However, even where the image viewer of the HMD is configured other than with such telecentric spacing (e.g., with substantially, but not strictly matching spacing, or e.g., with otherwise unmatched spacing), lens 17 should be modeled/implemented so as to enable imaging within acceptable performance (e.g., supporting an adjustment range of interpupilary distance (IPD)).

Having passed through first relay lens 15, the light is propagated to a nominal stop plane 16′. If there were no scattered light in the image viewer, the physical limits of the illumination source 12 may correspond to a functional telecentric stop. However, if scattered light is present, a true, physical stop may be provided in the vicinity of the true telecentric stop plane (e.g., toward improving contrast). This stop can be an aperture “nominally” close to the telecentric stop position, or the limited size of splitting mirror element 16.

At nominal stop plane 16′, an image is provided which is an approximate image of the image illumination source 12. In an example embodiment, the nominal stop plane 16′ is provided by a splitting mirror 16. In an example embodiment wherein the image viewer is comprised in a hybrid HMD as disclosed herein, the splitting mirror may comprise two mirror elements, left splitting mirror element 16L and right splitting mirror element 16R (further described below in relation to FIG. 3A). In an example embodiment, splitting mirror 16 generally has physical dimensions that may provide a stop.

It is understood that various true or functional stops may be employed and/or exploited in an image viewer. Generally, a stop may be employed and/or exploited to constrain propagated light (e.g., stray light and/or light undesirably scattered by an optical element prior to the stop) and, in so doing, address performance degradation that might be associated with such light (e.g., contrast degradation that might arise if the scattered light were to pass). In an HMD having telecentric characteristics (e.g., supporting an adjustment range of IPD), any such stop may comprise a telecentric stop, i.e., supporting the telecentric characteristics of the HMD relating to an adjustment range of IPD. As an example, the display device 102—via the display unit 14, the illumination source 12 and/or the illumination mirror 22—may provide a functional stop (e.g., via the size and/or location of the display unit 14 and/or the irradiance (area and/or spatial intensity) of the illumination source 12). As another example, a true, physical stop may be disposed at or near splitting mirror 16 (which stop, as stated above, may be implemented using the size of the mirror alone or using the mirror together with selected, additional structure). As yet another example, a true, physical stop may be disposed between second relay lens 17 and intermediate image plane 18, which stop may be variously implemented (including, e.g., using shutter film or a filter). As another example, provided a stop advances its purpose (e.g., to at least some selected and/or sufficient degree based on applicable engineering criteria), one or more true, physical stops may be employed, with each (i) implemented as is practical for the image viewer (e.g., consistent with one or more design criteria, as in the examples above or otherwise) and/or (ii) disposed wherever it is mechanically practical to place it.

After nominal stop plane 16′, the light propagates on through second relay lens 17 to intermediate image plane 18. In an example embodiment, intermediate image plane 18 may be implemented so as to substantially replicate the display plane of display unit 14. In this example embodiment, the second relay lens is modeled and disposed relative to the intermediate image plane 18 so as to precisely focus an intermediate image on the intermediate image plane 18. In this example embodiment, if the optical components prior to plane 18 provide, e.g., 1:1 magnification, relatively low distortion and relatively high resolution, the intermediate image may be a substantially close replication of the image provided by the display device 102 (i.e., in FIGS. 2, via the transmissive microdisplay). In such embodiment, the magnification depends on the ratio of focal lengths of first relay lens 15 and second relay lens 17, as is well known in to persons of ordinary skill in the art. However, it is understood, that in example embodiments, magnifications may be variously implemented (e.g., other than 1:1), e.g., responsive to and toward resolving applicable engineering criteria (e.g., toward designing an eyepiece 20 with a selected field of view, selected eye relief, and/or selected exit pupil).

In an example embodiment, illumination lens 13, the first relay lens 15 and/or the second relay lens 17 may be identical or substantially identical. In such embodiment, it is expected that use of one lens for various optical components in the image viewer may have various advantages, including, as examples: reducing cost of the lenses and/or the image viewer; simplifying logistics in ordering and/or handling lenses; and/or enhancing manufacturing (e.g., efficiencies in assembling image viewers).

From intermediate image plane 18, light is propagated through field lens 19 and, then, on through eyepiece 20 to the exit pupil 21. Generally, field lens 19 may be modeled and/or implemented toward having selected eye relief between eyepiece 20 and the exit pupil 21. In an example embodiment, field lens 19 may be modeled and/or implemented so as to provide clearance sufficient for a user's spectacles.

FIGS. 2A and 2B illustrate eye relief L, L′, eye boxes 27, 27′ and exit pupils 21, 21′. In an example embodiment, an image viewer 100, 100′ may be designed and/or implemented so as to provide: a selected exit pupil, a selected eyebox, and/or a selected eye relief. In FIGS. 2A, 2B, the exit pupil (an area) is represented, in one dimension, by the height of the lines referenced by respective reference numerals 21, 21′. In an example embodiment, an exit pupil should be provided responsive to, and/or toward resolving, various criteria, including: (a) it should have an area sufficiently large relative to the typical user's pupil (and variations therein, i.e. associated with light intensity) so as to adequately accommodate the typical user's pupil in the intended applications, in that at least part of the user's pupil must be within the exit pupil in order to for the user to see the image transmitted from the eyepiece; (b) it should have an area that is sufficiently large relative to the user's pupil so as to provide comfortable viewing; and/or (c) it should be provided so as to reduce or avoid shortfalls in image quality (e.g., reduce/avoid undesirable loss of light intensity). Generally, an exit pupil should be provided so as to optimize delivery of transmitted light (i.e., that light forming the image) to the user's eye in the applications for which the exit pupil's image viewer is intended.

As is known to persons of ordinary skill in the art, “eye relief” refers to the distance from the vertex of the eyepiece's last optical surface to the location along the eyepiece's optical axis at which the exit pupil is ideally located, e.g., where light rays from all points in the defined object field (i.e., display 14) occupy a common area. In example embodiments, the exit pupil has the same or larger area as a user's pupil, e.g., so as to allow for non-critical positioning and comfortable viewing. As is also known to persons of ordinary skill in the art, “eyebox” refers to a three-dimensional image space (i.e., an image volume) formed by extending the exit pupil along the optical axis in either direction from the exit pupil's ideal position, and within which space the user can view the entire image. That is, an eyebox, generally, is an image volume (a) within which the user's pupil may move around while intercepting a complete image, e.g., intercepting all pixels of the display plane of display unit 14 and (b) outside of which the user's pupil will intercept an incomplete or partially dimmed image, e.g., intercepting less than all pixels of the display plane of display unit 14. Relative to the eyebox and to the exit pupil, several characteristics of image quality of the image viewer 100, 100′ may depend on the placement of the user's pupil, which quality characteristics include, as examples: resolution, distortion, and vignetting.

In an example embodiment, an image viewer 100, 100′ may be modeled/implemented including, e.g., toward providing selected characteristics of eyeboxes 27, 27′ and/or exit pupils 21, 21′. To illustrate, in FIG. 2A, an example embodiment of an image viewer 100 has selected optical components (e.g., field lens 19 and eyepiece 20) and provides an eye box 27 of selected volume and an exit pupil 21 of selected area. By comparison, in FIG. 2B, an example embodiment of an image viewer 100′ comprises selected optical components (e.g., field lens 19, eyepiece 20 and diffuser 26) and provides an eyebox 27′ of relatively larger volume than eyebox 27 and an exit pupil 21′ of relatively large area than exit pupil 21.

In an example embodiment, diffuser 26 may be variously implemented, including, as an example, using a microlens array or a diffusing surface coating. In the various implementation, the diffuser 26 generally is modeled and/or implemented consistent with one or more factors, including, as examples: (a) the diffuser should be properly disposed (e.g., on, in, at or otherwise associated with intermediate image plane 18 on the rear surface of field lens 19); (b) the diffuser should expand a higher f-number cone of light into a lower f-number cone that fills out eyebox 27; and/or (c) the diffuser's structure should be invisible or substantially invisible to the user (i.e., relatively invisible, substantially invisible or, at least, not noticeably visible to a typical user, with respect to the image, such as the image from the display unit 14 shown in FIG. 2), such as by being implemented not to add, or not to substantially add, graininess or Morier patterning with the pixel structure or color filter structure of display unit 14, or otherwise. It is noted that a microstructure to broaden the dispersion of light so as to expand exit pupil is disclosed in Hebert, U.S. Pat. No. 6,972,735, Patent Date Dec. 6, 2005, which disclosures, as well as all other disclosures thereof, are hereby incorporated by reference, as if set forth herein in its entirety, for all purposes.

Turning to FIGS. 3A, 3B, an example embodiment of an image viewer is shown that employs various optical components, and wherein the image viewer is folded at various folding planes. In an example embodiment, an image viewer consistent with the example embodiment of FIGS. 3A, 3B may be understood as being comprised in a hybrid head mounted display (HMD). FIG. 3A is a top view of a central core 50 and, disposed laterally thereto, respective subassemblies 52L and 52R. FIG. 3A shows the optical components of the image viewer and the components of the display device, while referencing the housing/mechanics 60, 62L, 62R of, respectively, the central core and each subassembly. FIG. 3B is a side view of the central core 50, omitting reference to the housing mechanics 60. In each of FIGS. 3A, 3B, the optical components of the image viewer and the components of the display device are arranged via folding, e.g., for compactness.

In the example embodiment of FIGS. 3A, 3B, the central core 50 is shown to comprise various optical components of the image viewer, including, e.g., first relay lens 15, rotational mirror 24, a left splitting mirror 16L and a right splitting mirror 16R. The central core 50 is shown to comprise various components of the display device, including, e.g., an illumination source 12 that comprises a right illumination source 12R and a left illumination source 12L which sources 12R, 12L are displaced horizontally from the core's central axis so as to focus through corresponding right and left splitting mirrors 16R, 16L of the image viewer. It is expected that this one-to-one arrangement of illumination sources and splitting mirrors in the central core 50 may offer advantages, including, e.g., more convenient and/or efficient illumination, enhanced alignment and/or opportunities to provide for uniformity and/or balance. Moreover, it is understood that this one-to-one arrangement of illumination sources and splitting mirrors in the central core 50 may offer the option of three-dimensional (3D) viewing, e.g., by multiplexing the two illumination sources 12R, 12L with respect to corresponding right eye and left eye image data. It is noted that use of two illumination sources, one for each optical channel, is disclosed in Hebert, U.S. Pat. No. 6,972,735, Patent Date Dec. 6, 2005, which disclosures, as well as all other disclosures thereof, are hereby incorporated by reference, as if set forth herein in its entirety, for all purposes.

As shown in FIGS. 3A, 3B, in an example embodiment, the illumination lens 13 may be modeled and/or implemented other than consistent with the lens design of FIG. 1E (as described above). However, it is to be understood that, in an example embodiment, lens 13 may be modeled and/or implemented consistent with the lens design of FIG. 1E.

As shown in FIGS. 3A, 3B, the right and left subassemblies 52R, 52L comprise various optical components of an image viewer implemented in a hybrid HMD, and have respective right and left exit pupils 21R, 21L. The optical components comprise, for the right subassembly 52R: a right second relay lens 17R; a right field mirror 25R; a right field lens 19R; and a right eyepiece 20R. The optical components comprise, for the left subassembly 52L: a left second relay lens 17L; a left field mirror 25L; a left field lens 19L; and a left eyepiece 20L. In an example embodiment, corresponding optical components of the respective right and left subassemblies may be identical or substantially identical (e.g., right and left second relay lenses 17R, 17L may be modeled and/or implemented so as to be identical or substantially identical in lens design, size, weight, performance, etc.).

Turning to FIG. 3C, an example embodiment is shown that employs a display device 102 comprising a reflective display unit 14B. In this example embodiment, light of the illumination source 12 is propagated by folding via illumination mirror 22 and by transmission through illumination lens 13. Lens 13 directs light through beamsplitter 23B and to the reflective display unit 14B. The light is reflected therefrom back to beamsplitter 23B. At beamsplitter 23B, the light is reflected to first relay lens 15 and, therefrom, is transmitted as described above. In an example embodiment, the beamsplitter 23B would be a polarizing beam splitter. In other example embodiments, polarization may be implemented using other polarizing component(s).

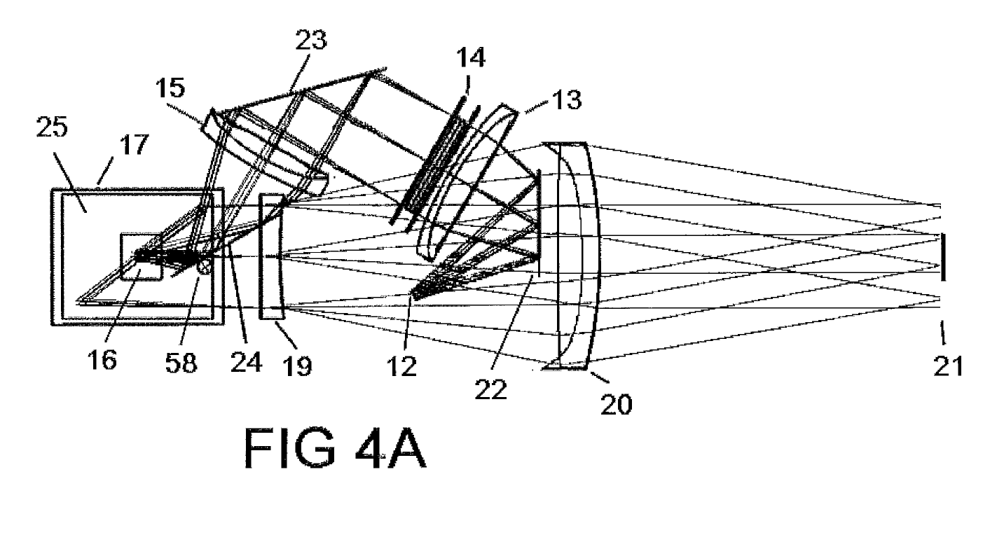

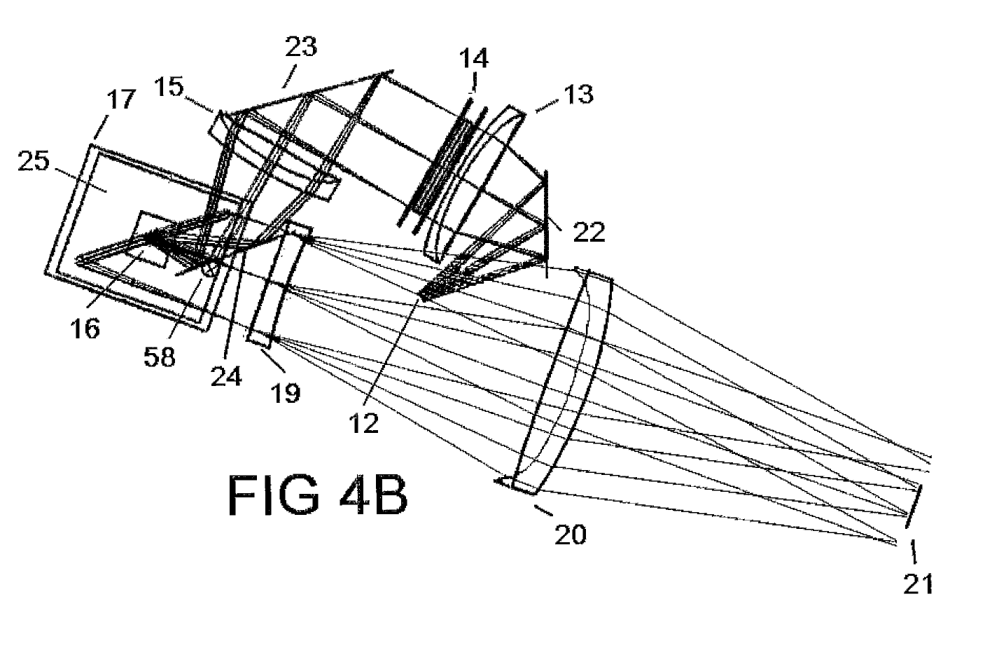

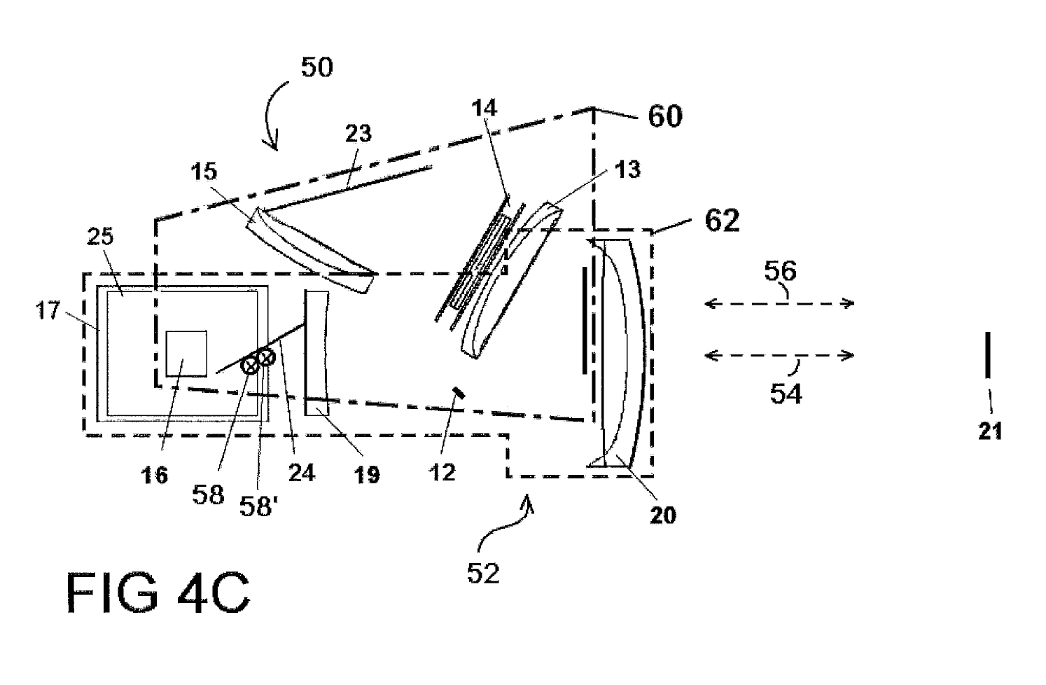

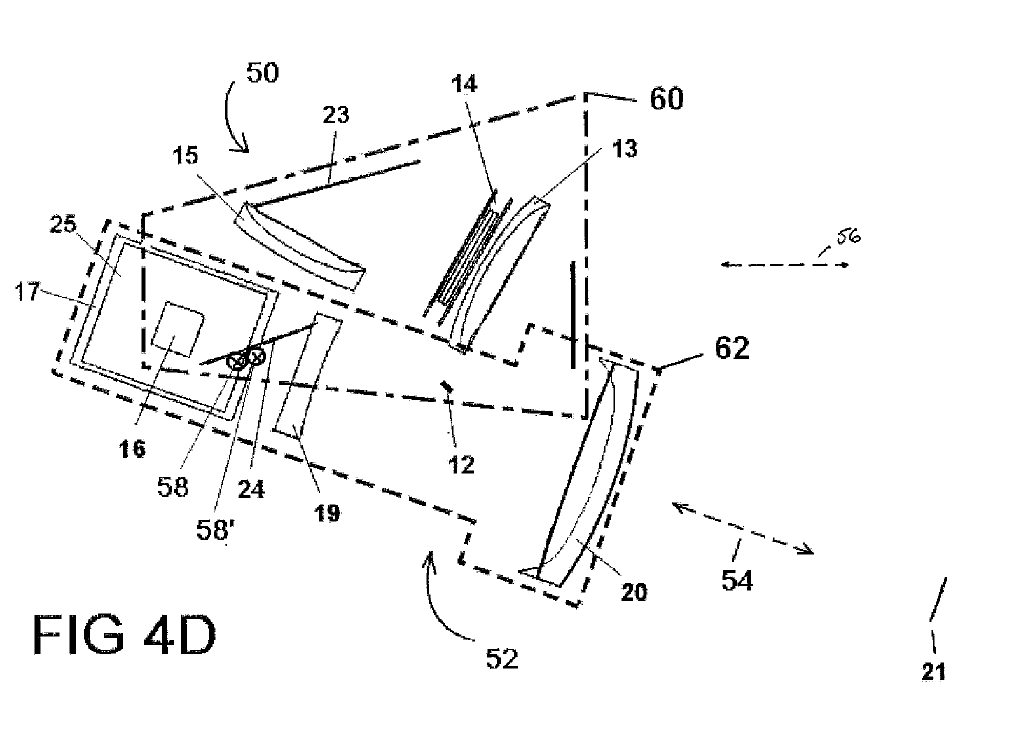

Turning to FIGS. 4A-D, example embodiments are shown comprising an image viewer, together with a display device, in side view. An image viewer consistent with the example embodiment of FIGS. 4A-D may be understood as being comprised in a hybrid head mounted display (HMD).

In FIGS. 4A-D, example embodiments have various optical components of an image viewer and components of a display device, and are folded at various folding planes. In FIGS. 4C-D, an example embodiment has, without reference to light cones, a central core 50 and, disposed laterally thereto, a subassembly 52. In FIGS. 4C-D, an example embodiment references the housing/mechanics 60, 62 of, respectively, the central core 50 and the subassembly 52. It is understood that, in a hybrid HMD application, subassembly 52 may represent a left subassembly 52L and/or a right subassembly 52R and, as such, housing/mechanics 62 may represent left and/or right housing/mechanics 62L, 62R.

FIGS. 4A-B show various light cones, as transmitted through and/or by respective of the image viewer's optical components and the display device's components. FIGS. 4A-B omit to reference housing/mechanics 60, 62.

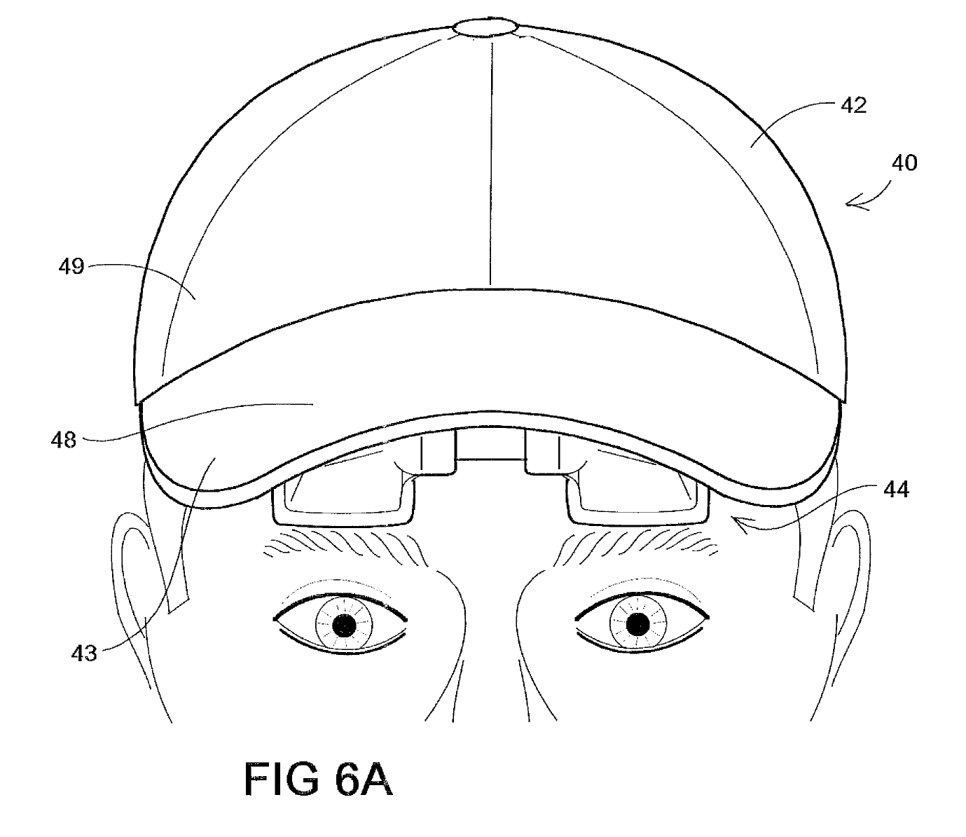

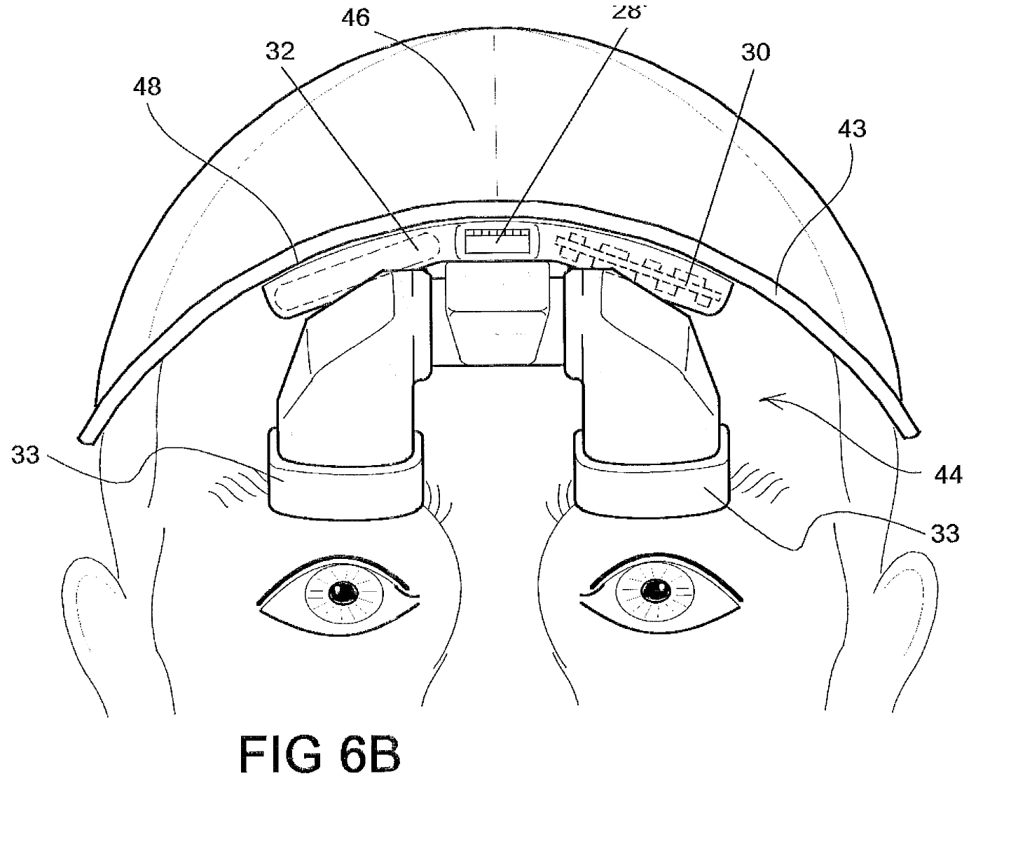

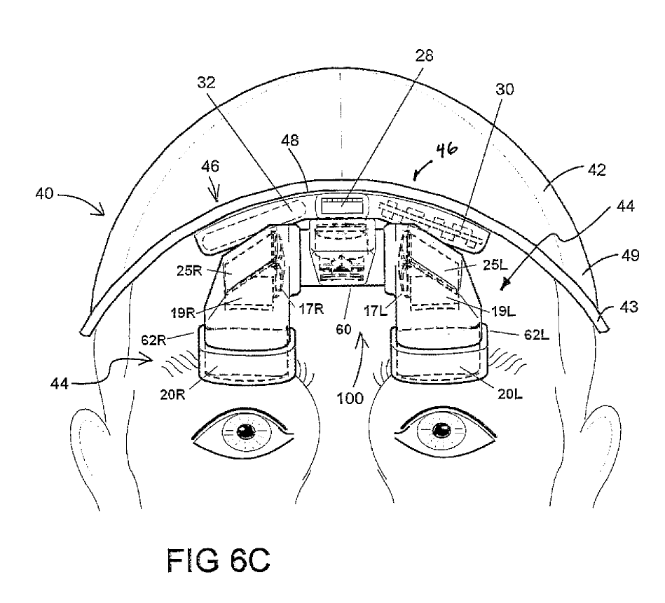

FIGS. 4A-D illustrate that, in example embodiments, the disposition of subassembly 52 may be adjusted relative to the disposition of central core 50. Also, the disposition of subassembly 52 may be adjusted relative to headgear 42 (as headgear 42 is disclosed with reference to FIG. 6). Although not depicted in FIG. 4, it is understood that central core 50 may be implemented to be adjustable relative to headgear 42, which adjustment may be implemented with or without adjustment of subassembly 52.

In an example embodiment, adjustment as disclosed above may be provided for various purposes. Examples of such purposes include: (a) to enable the user to selectively align the optical axis 54 of the subassembly 52 with the user's pupil (e.g., to aim or otherwise position the delivered image in the user's line of sight); (b) to enable the subassembly 52 to be removed from, or substantially removed from, the user's line of sight, or otherwise to be rendered unobtrusive or substantially unobtrusive to the user; and/or (c) to enhance appearance (e.g., to store the subassembly so that the image viewer is unobtrusive or substantially unobtrusive as to others). If the adjustment is implemented, the adjustment generally should be implemented so as to deliver its purpose, while responding to and/or toward resolving among applicable engineering criteria (e.g., if to enable user alignment, the implementation may account for physical parameters, such as the space implicated/available for adjustment, the implicated mechanicals, and/or one or both subassembly's dimensions, exit pupil, eye relief, eyebox, and/or position relative to the user's pupil). (Hereinafter, adjustment of this form is sometimes referred to as “general adjustment”.)

To illustrate, in the example embodiments of FIGS. 4A and 4C, the subassembly 52 is disposed in a selected first position, such first position being characterized by the optical axis 54 of the subassembly 52 being parallel or substantially parallel to, or forming a relatively small acute angle with, a central axis 56 of the central core 50. Also to illustrate, in FIGS. 4B and 4D, the subassembly 52 is disposed in a selected second position, such second position being characterized by the optical axis 54 of the subassembly 52 forming a larger angle with the central axis 56 of the central core 50, i.e., larger relative to the angle formed with respect to the first position.

Although, in these Figures, general adjustment is illustrated by using a first position and a second position, it is to be understood that general adjustment may be implemented so as to include other positions. Examples of these other implementations include: (a) an adjustment range that sets either or both of these positions as the range's boundaries; (b) an adjustment range that sets neither of these positions as the range's boundaries; (c) an adjustment range that has either or both boundaries outside the range set by these positions; and/or (d) an adjustment range that has either or both boundaries inside the range set by these positions.

In an example embodiment, general adjustment may be implemented through rotation of the subassembly 54 relative to the central core 52. In such example embodiment, rotation of the subassembly 54 may be enabled so that, with such rotation, the relative dispositions, alignments, arrangement and/or interactions among selected optical components thereof are maintained or substantially maintained. As shown in the example embodiments of FIGS. 4A-D, the relative dispositions, alignments, arrangements and interactions of the second relay lens 17, the field mirror 25, the field lens 19 and the eyepiece 20 are the same, or substantially the same, in both the first and second positions.

In an example embodiment, rotation of the subassembly 54 relative to the central core 52 may be enabled, so that, with such rotation, the splitting mirror 16 of the central core 52 moves so as to maintain or substantially maintain its relative disposition, alignment, arrangement and/or interaction with the optical path of the subassembly 54. In the example embodiments shown in FIGS. 4A-D, the relative dispositions, alignments, arrangements and interactions between the splitting mirror 16 and the subassembly's optical components (e.g., the second relay lens 17, the field mirror 25, the field lens 19 and the eyepiece 20) are the same, or substantially the same, in both the first and second positions.

In an example embodiment, rotation of the subassembly 54 relative to the central core 52 may be enabled so that, with such rotation, the central core's splitting mirror 16 and rotational mirror 24 move relative to one another so as to maintain, or substantially maintain, their optical interaction. Generally, by doing so, the image will be maintained, or substantially maintained, in the optical path of the subassembly 54. It is expected that failure to do so during general adjustment, without other corrections/adjustments, may tend to result in undesirable rotation of the image on the intermediate image plane 18 and, thus, a potentially undesirable perception of the image by the user.

In an example embodiment, general adjustment may be enabled by providing for rotation, as one, of selected optical components (e.g., from the splitting mirror 16 through eyepiece 20), about a rotational axis 58. In such embodiment, the rotational mirror 24 may also be enabled to rotate about the rotational axis 58. In such an embodiment, for any selected amount of general adjustment, such selected optical components may be implemented so as to rotate about the rotational axis 58 through an angle that is greater than (e.g., a multiple of, such as twice) the angle that rotational mirror (24) rotates about the horizontal axis 58. As FIGS. 4A-D illustrate, for an adjustment from the first position to the second position, rotation of the optical components is illustrated as 20° and rotation of the rotational mirror 24 is illustrated as 10°. The relative angular rotations (e.g., any rotational multiplier) may be variously implemented, including so as to respond to, and toward resolving, applicable engineering criteria (e.g., the available volume within which mirror 24 may rotate and/or the adjustment range desired for the subassembly 54).

In an example embodiment, general adjustment may be enabled: (a) by providing for rotation, as one, of selected optical components (e.g., from the splitting mirror 16 through eyepiece 20), about a rotational axis 58 and/or (b) by providing for rotation of the rotational mirror 24 about a rotational axis 58′. In such an embodiment, for any selected amount of adjustment, selected optical components may be implemented so as to rotate about the rotational axis 58 through an angle that is the same as or different from (e.g., greater than, less then, or a multiple of, such as twice) the angle that rotational mirror (24) rotates about the horizontal axis 58′. Generally, in such embodiment, the rotational axis 58 should be relatively similar (e.g., in proximity, alignment and/or coincidence) to the rotational axis 58′. Sufficient similarity in such axes 58, 58′ may be variously implemented but, generally, should be implemented so that, e.g., the image is transmitted without rotation or other degradation. To illustrate, where such embodiment is implemented in a hybrid HMD application having telecentric characteristics, the axes 58, 58′ should be sufficiently similar so that, with rotation, the movement of optical components relative to the rotational mirror 24 minimizes or avoids the image (a) missing an aperture (in whole or in part) of any optical components (e.g., from the split mirror 16 through the eyepiece 20) and/or (b) being blocked (in whole or in part) by any stop (e.g., a telecentric stop).

In an example embodiment, general adjustment may be enabled by providing for: (a) rotation, as one, of selected optical components (e.g., from the second relay lens 17 through eyepiece 20), about a rotational axis 58; (b) rotation of the rotational mirror 24 about a rotational axis 58′; and/or (c) rotation or other movement of the splitting mirror 16. Such rotation or other movement of the splitting mirror 16 may be about a rotational axis 58″ (not shown), which axis 58″ generally is implemented as described above. Such rotation or other movement of the splitting mirror 16 may also be otherwise implemented (including as a combination of rotation about any one or more axes and/or with other movement). In any case, the implementation generally should be accomplished so as to minimize or avoid image degradation associated with general and/or IPD adjustment (as IPD adjustment is described further below).

As to the example embodiments illustrated in FIGS. 4A-D and other embodiments described based thereon, it is understood that general adjustment is physically enabled and/or supported using selected mechanical devices, articles and/or associated technologies (“general adjustment technology”). It is also understood that general adjustment technology is indicated by and within the reference to housing/mechanicals 60, 62. It is understood that the design and implementation of general adjustment technology is well known to persons of ordinary skill in the art.

Turning to FIGS. 5A-B, an example embodiment is shown that supports adjustment of interpupilary distance (IPD). (Hereinafter, this form of adjustment is sometimes referred to as “IPD adjustment”.) As to an embodiment supporting IPD adjustment, FIGS. 5A′-B′ show representative, expected performance curves associated with two values of IPD 66, 66′. In these FIGS. 5A-B, the example embodiment may be any embodiment illustrated in other Figures hereof and/or any other example embodiment based on such illustrations, this detailed description or other disclosures hereof.

In FIGS. 5A-B, an example embodiment illustrates that IPD adjustment may be implemented by enabling adjustment of the relative distance between (a) the left splitting mirror 16L and the respective left second relay lenses 17L and/or (b) the right splitting mirror 16R and the respective right second relay lenses 17R. IPD adjustment may be variously implemented in an example embodiment contemplating an HMD that supports telecentric characteristics, wherein the left and right splitting mirrors 16L, 16R are disposed in a central core 50, and wherein the left and right second relay lenses 17L, 17R are comprised among optical components of left and right subassemblies 52L, 52R. In such HMD embodiment, IPD adjustment may be implemented, as an example, by enabling lateral or substantially lateral movement of either or both subassemblies 52L, 52R relative to an otherwise stationary central core 50, wherein lateral movement may be movement in a direction having a component common with an axis generally associated with IPD. It is noted that an approach to IPD adjustment is disclosed in Hebert, U.S. Pat. No. 6,972,735, Patent Date Dec. 6, 2005, which disclosures, as well as all other disclosures thereof, are hereby incorporated by reference, as if set forth herein in its entirety, for all purposes.

As to IPD adjustment, it is understood that the IPD adjustment range may be variously implemented, including, as an example, responsive to a range of IPDs expected or known in a selected population (e.g., populations reflecting heritage, gender, age, and/or residency of the United States and/or other jurisdictions). To illustrate, IPDs ranging from 49 mm to 65 mm are thought to cover a significant percentage of the adult population in the United States.

As to a selected IPD adjustment range, the adjustment is optically enabled, at least in part, through selection of the second relay lenses 17 and/or the field mirrors 25. Selection of lens 17 and/or mirrors 25 includes, for example, proper size and/or proper arrangement, e.g., so as to adequately accommodate the convergence/divergence of light, respectively incident thereon, over the IPD adjustment range (which convergence/divergence is illustrated in FIGS. 5A, 5B). It is noted that, in order to provide IPD adjustment without holding the optical path length constant, embodiments in accordance with the subject matter of this disclosure support telecentric characteristics, which telecentric characteristics may be established by collimating the light carrying the image (e.g., as shown in FIG. 2, by collimating the light from the illumination source 12 via illumination lens 13 for application to the transmissive microdisplay and transmission through a collimated image space comprising other optical components, including first and second relay lenses 15, 17).

Further as to IPD adjustment, it is understood that IPD adjustment is physically enabled and/or supported using selected mechanical devices, articles and/or associated technologies (“IPD adjustment technology”). It is also understood that IPD adjustment technology is indicated by and within the reference to housing/mechanicals 60, 62, as shown in various Figures herein. It is understood that the design and implementation of IPD adjustment technology is well known to persons of ordinary skill in the art.

Turning to FIGS. 5A′, B′, MTF curves 4 are shown based two adjustment positions for IPD as may be encountered in a hybrid HMD supporting telecentric characteristics consistent with the subject matter of this disclosure. The MTF curves 4 are representative curves presented so as to illustrate the expected performance of the HMD for such IPD positions. As is illustrated by such curves 4, IPD adjustment should be implemented so as to result in only minor (or negligible) differences in performance (e.g., resolution) across the adjustment range. Generally, such performance differences are expected to be supported by HMDs, image viewers and other systems consistent with the disclosures hereof.

Turning to FIGS. 6A-C, a head mounted display (HMD) system 40 is shown. In an example embodiment, a HMD system 40 comprises headgear 42 and a HMD assembly 44. In such example embodiment, a HMD assembly 44 comprises an image viewer 100, 100′ and/or a display device 102 (or selected one or more components of such device 102).

In an example embodiment, a HMD system 40 comprises a modular assembly 46. A modular assembly 46 may be variously implemented. As an example, a modular assembly 46 may be implemented so as to be comprised in an HMD assembly 44, together with an image viewer 100, 100′ and/or a display device 102 (or selected one or more components of such device 102). As an example, a modular assembly 46 may be implemented integrated in headgear 42 (e.g., for permanent attachment). As another example, a modular assembly 46 may be implemented so as to be detachable from, and re-attachable to, headgear 42 (e.g., at the user's selection). In any such example, a modular assembly 46 may be implemented either/both (i) within or substantially within any one or more of the various components of the headgear 42 and/or (ii) as an attachment, protrusion, or other addition to any one or more of the various components of the headgear 42. If the modular assembly 46 is comprised in an HMD assembly 44, the modular assembly 46 may be implemented so as that the HMD assembly 44 is attached via the modular assembly 46 to the headgear 42 (e.g., in permanent attachment or otherwise).

As an example, a modular assembly 46 may be implemented to comprise: (a) one or more peripherals connectors 28; (b) driver/interface electronics 30; and/or (c) one or more stow units 32. It is understood that, in an example embodiment, any one or more of a peripherals connector 28, driver/interface electronics 30, and/or a stow unit 32 may be implemented as a component of an HMD system 40, but separately from the modular assembly 46.

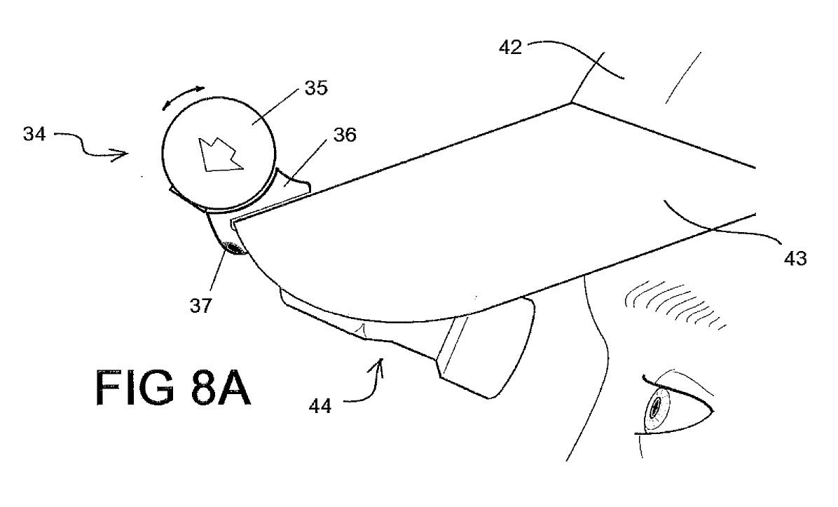

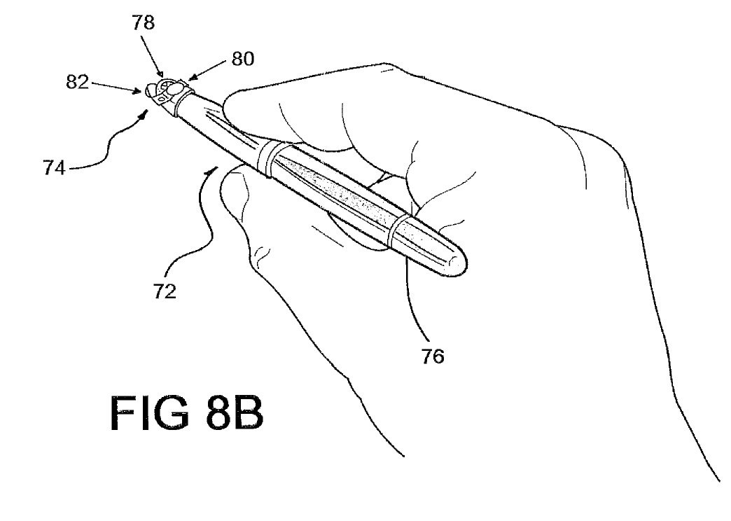

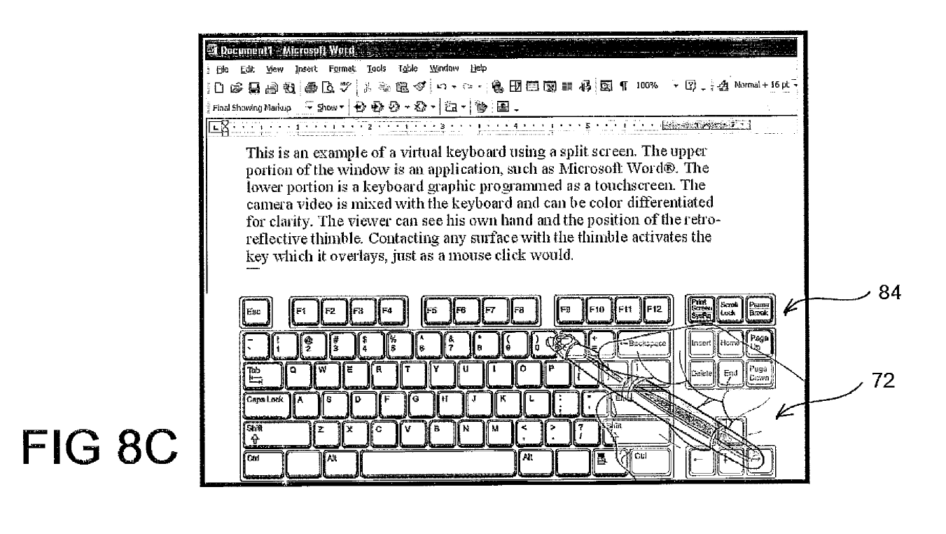

A peripherals connector 28 may be variously implemented. In an example embodiment, a peripherals connector 28 is implemented to provide one or more selected connections between a selected peripheral (see FIG. 8) and one or more of the various components of the HMD system 40. A peripherals connector 28 may be implemented, as examples: electrical (i.e., to provide/receive power); electronic (i.e., to provide for transmission and/or reception of various signals, whether electronic, opto-electronic or otherwise, including control, data, media, and/or other signals, e.g., to provide an image signal to a display device and/or an image viewer); mechanical (i.e., to provide for mechanical attachment and/or support for/from a peripheral, e.g., to enable proper removable attachment of a peripheral); and/or optical (i.e., to provide for proper attachment of, and/or proper receipt of an image from, an optical source, e.g., by providing for alignment of the image in transmission from the optical source to the image viewer). A peripherals connector 28 may use or be compatible with various technologies, including, as examples: analog and/or digital technologies; optical, electronic and/or opto-electronic technologies; wired and/or wireless technologies; serial and/or parallel technologies; and/or standards-based and/or proprietary technologies. A peripherals connector 28 may use or be compatible with various protocols and/or specifications, including, as examples: hot shoes, audio connections, USB, Firewire, GPIB, Composite Video, Component Video, S-Video, DVI, and/or VGA/SVGA/XVGA.

It is understood that more than one peripherals connectors 28 may be implemented in HMD system 40 in order to support a selected group or number of connections and/or peripherals. It is further understood that the numbers and/or types of peripherals connectors 28 generally should be implemented responsive to, and/or toward resolving among, applicable engineering criteria (e.g.: the field application to which the HMD system is being designed; the size, weight and form factor of the peripherals; the mounting area/space available and/or usable in relation to the headgear 42; and/or the support/stability provided via the headgear 42).

Driver/interface electronics 30 may be variously implemented. Driver/interface electronics 30 may be implemented to drive, enable, support or otherwise contribute to operation of, as examples: (a) one or more peripherals connectors 28; (b) an image viewer 100 (e.g., as to an integrated display unit 14, a user detection technology feature 90, and/or other features); (c) a display device 102; (d) one or more peripherals connected to respective peripherals connectors 28; and/or (e) any combination of these.

One or more stow units 32 may be variously implemented. In an example embodiment, stow units 32 are implemented responsive to the units' respective purposes. In an example embodiment, a stow unit 32 may be implemented so as to enable the user to stow various peripherals, one or more of which peripherals (i) may or may not be used via a peripherals connector 28 and/or (ii) may be stowed in a stow unit 32 either/both in use or not in use. In such example embodiment, a stow unit 32 may be implemented to stow, from time to time, at various times, or all the time, peripherals that include, as examples: a camera (e.g., a digital camera, a video camera, a night vision camera, and/or a video binocular); an optical source (e.g., binoculars); headphones (e.g., earbud headphones); a Bluetooth device (e.g., an interface to a television source, to other video source, and/or to an audio source); a cell phone (e.g. a smart phone); a music player (e.g., an IPOD®); a personal digital assistant; any of various computing devices (e.g., of any of various, but of form factor proportional to that of the respective stow unit 32); a gaming station; a storage device (e.g., a LifeDrive™, any of various so-called thumb drives, or other storage devices, whether having built in interface technology or employing the driver/interface electronics 30); a connector (e.g., a USB cable to connect between a remote or attached peripheral and the HMD system, such as connection to a personal computer via peripherals connector 28); and/or a battery (e.g., a back-up and/or extended life battery). It is noted that, as to peripherals comprising optical components (e.g., a camera and/or an optical source), one or more of the optical components therein may be modeled and/or implemented consistent with a lens design of this disclosure, e.g., responsive to, and/or toward resolving among, applicable engineering criteria engineering criteria associated with any such peripheral.

In an example embodiment, depending on the peripheral stowed therein, the stow unit 32 may provide various connections so as to couple a stowed peripheral with one or more other components of the HMD system 40 (e.g., the same or substantially similar to any one or more of the electrical, electronic and/or other connections described above with reference to the peripherals connectors 28). In an example embodiment, a stow unit 32 may comprise a pocket (e.g., sewn into or onto a cap or formed in other headgear, with or without a pocket closure or peripheral retaining device).

Headgear 42 may be variously implemented. As examples, headgear 42 may be implemented via: a cap (e.g., a baseball cap, a fishing cap, a sailing cap, a golf cap, a driving cap, a bicycling cap, and/or an officiating cap); a hood (e.g., of a sweatshirt, a snowboarding jacket and/or a ski jacket); a visor (e.g., a sun visor); a sporting helmet (e.g., a bicycle helmet, a skiing helmet, a snowboarding helmet, a kayaking helmet, a motorcycling helmet, a driving helmet, a jockey's helmet, and/or an officiating helmet); service headgear (e.g., a helmet for army, navy, air force, NASA and/or special forces, and/or headgear for fireman hat and/or); protective headgear (e.g., a hard hat); professional headgear (e.g., for surgeons, television cameramen, and/or journalists); gaming headgear; fashion hats (e.g., cowboy hats); and/or customized devices (e.g., designed and/or implemented to serve as headgear 42).

In an example embodiment, headgear 42 comprises a mount 48 and a base 49. The mount 48 refers to connection, within the HMD system 40, between the headgear 42 and the HMD assembly 44. The base 49 refers to connection between the HMD system 40 and the user's head. Generally, the mount 48 and base 49 may be variously implemented, which implementations should respond to, and/or resolve among, various engineering criteria, including, as examples: (a) the type of headgear 42; (b) the applications to which the HMD system 40 is designed and used; (c) desired stability of the HMD system 40 on the user's head, both during use and not during use of the HMD assembly 44 (e.g., responsive to torque arising from the weight/disposition of the HMD assembly 44 and/or of any peripherals associated with the modular assembly 46, such as via peripherals connectors 28 and/or the stow unit 32); (d) desired distribution of weight, pressure and/or other support criteria relating to the HMD system 40, around and/or about the user's head; (e) desired comfort of the HMD system 40 on the user's head; (f) fashion or other appearance criteria; and/or (g) safety. It is noted that, as to certain headgear, responding to and/or resolving among engineering criteria is disclosed in Kaufmann et al., U.S. Pat. No. 6,480,174, Patent Date Nov. 12, 2002, which disclosures, as well as all other disclosures thereof, are hereby incorporated by reference, as if set forth herein in its entirety, for all purposes.

In FIGS. 6A-C, an example embodiment of an HMD system 40 is shown wherein the headgear 42 comprises a cap (e.g., a baseball cap). In this example embodiment headgear's base 49 may comprise the cap's sweatband and the headgear's mount 48 may comprise the cap's visor 43.

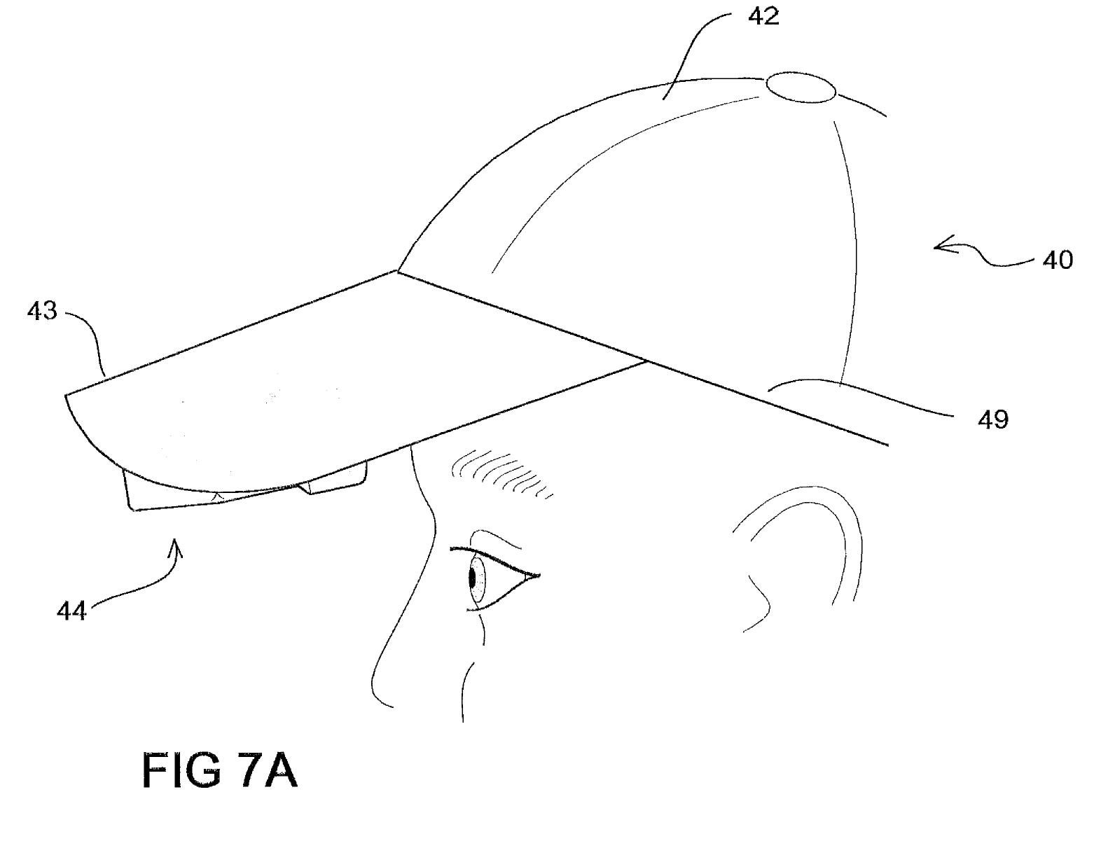

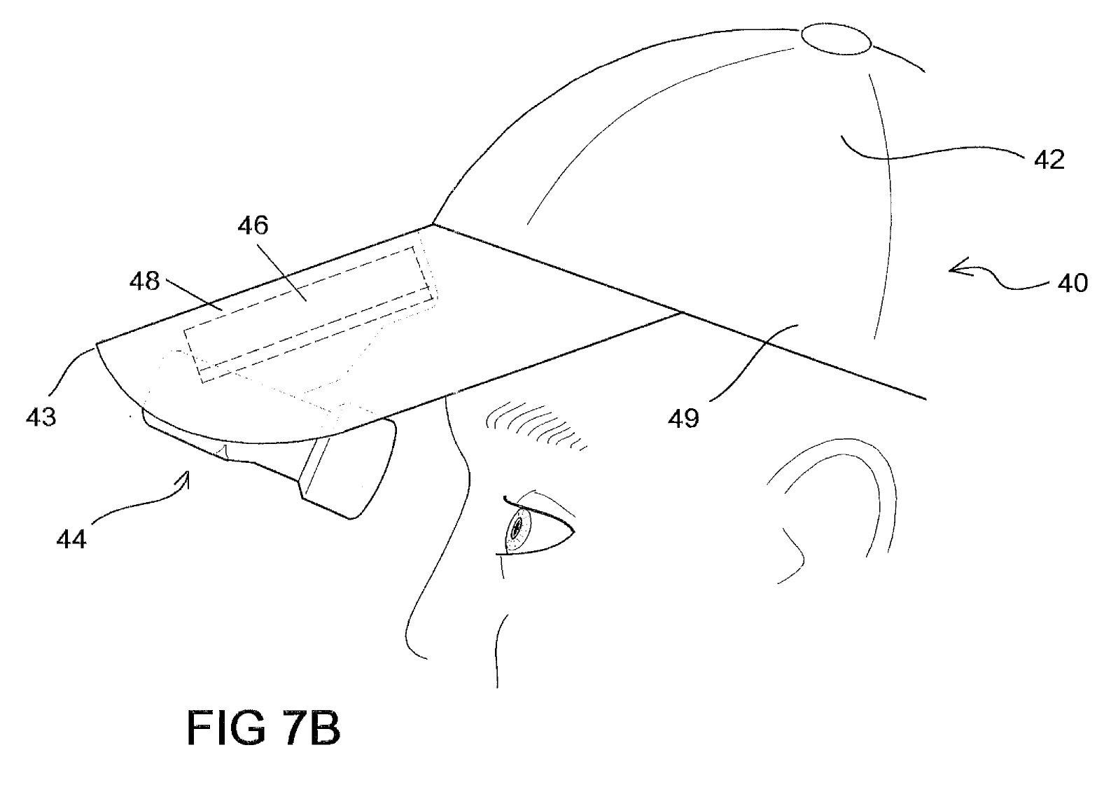

FIGS. 6A-C and FIGS. 7A, B illustrate an example of general adjustment (as above described). In FIGS. 6A and 7A, an HMD assembly 44 is generally adjusted so as to be tucked into the curvature of the cap's visor 43 when in a retracted position. In an example embodiment as illustrated, the retracted position is implemented so as to refer to tucking the left and right subassemblies 52L, 52R into such curvature. In another example embodiment (not illustrated), the retracted position may be otherwise implemented, e.g., so as to refer to tucking into such curvature or some other recess or location (i) the central core 50 (i.e., in such case, general adjustment is provided for the central core) and/or (ii) either/both the left and/or right subassemblies 52L, 52R. In any case, so tucked, as illustrated in FIGS. 6A and 7A, the HMD system 40 tends to be minimally noticeable to the user and/or others, e.g., by enabling the subassembly 52 to be removed from, or substantially removed from, the user's line of sight, or otherwise to be rendered unobtrusive or substantially unobtrusive to the user. As well, so tucked, the HMD system 40 tends to have an enhanced appearance (e.g., to store the subassembly 52 so that the image viewer is unobtrusive or substantially unobtrusive as to others).

In FIGS. 6B-C and 7B, an HMD assembly 44 is generally adjusted so as to be below the cap's visor 43, in a deployed position. In an example embodiment as illustrated, the deployed position is implemented so as to enable movement of the left and right subassemblies 52L, 52R (together and/or separately) to a location that facilitates use of the HMD assembly 44. As an example, in a deployed position, the user should be enabled to selectively align the optical axis 54 of the subassemblies 52L, 52R with the user's pupil (e.g., to aim or otherwise position the delivered image in the user's line of sight). Moreover, in a deployed position, the user should be provided with peripheral vision responsive to the application of the HMD system 40 (e.g., if peripheral vision is specified for the application, such vision may be specified to be at or above a level so as to maintain the user's necessary or desirable connection to their physical surrounding or, conversely, so that the user is at least not undesirably disconnected from those surroundings).

In FIGS. 6B-C, the HMD system 40 is illustrated with the user's head is tilted backwards so as to provide a view in alignment with the cap's visor 43. In such views, the HMD assembly 44 is shown, respectively, with and without reference to the components of the image viewer 100. It is noted that the eyepieces 20 of the HMD assembly 44 may be implemented to include a focus adjuster 33 so as to support user-adjustment of focus (e.g., a diopter adjustment).

As described above, the HMD system 40 may employ various peripherals. In an example embodiment, the HMD system 40 may employ various peripherals, at any time, alone and/or in combination. In such example embodiment, the user may be enabled to select which peripheral(s) to employ at any given time and for what duration. In an example embodiment, if peripherals are employed in combination, peripherals' number may be dependent on various factors, including: the ability of headgear's mount 48 and base 49 to accommodate such peripherals (e.g., to enable attachment the peripherals and/or to sufficiently perform when peripherals are attached); the number of available, compatible peripherals connections 28; peripheral's demand for power relative to available supply of power from an HMD-resident power source; and/or peripheral's demand for drive/interface resources relative to available supply of drive/interface resources from the HMD's driver/interface electronics 30).

In an example embodiment, one or more peripherals may be employed such that they are integrated in the HMD system 40. As an example, various storage devices and/or various image sources may be so integrated. In this example, the HMD system 40 may be implemented so that, other than the one or more integrated peripherals, either no additional peripherals may be employed or one or more additional peripherals may be employed (e.g., user-selected peripherals, times and/or durations).

In an example embodiment illustrated in FIG. 8A, an HMD system 40 employs a video camera 34 as a peripheral. As an example, a video camera 34 may be employed that functions as a computer monitor, as a TV monitor, and/or as an image source that acquires an image from the user's surroundings. As a computer monitor, the video camera 34 may communicate with a computing device toward providing images to the HMD assembly 44. As a TV monitor, the video camera 34 may communicate with a TV tuner toward providing images to the HMD assembly 44. As an image source, the video camera 34 may be designed and implemented to enable various features and/or functions in order to support a viewing experience. As examples, a video camera 34 implemented as an image source may be associated with images that are: acquired via selected optics (e.g., biocular and/or binocular means); not processed and/or processed for various effects (such as, sampling images for stereographic viewing); stored and/or not stored (e.g., responsive to the acquisition purpose); delayed or real/substantially real time; magnified or not magnified (e.g., high magnification for snapshots or video with a wider field, or for near-field magnification for visually-impaired augmentation). Moreover, a video camera 34 implemented as an image source may be support acquisition of images via various features and/or functions that are user-selected and/or system-selected (e.g., system selections that are defaults in the absence of user selections or that override a user selection responsive to certain sensed parameters). In the case of a surveillance application (e.g., for police and/or armed forces), a video camera 34 may be employed that operates in the infrared spectrum (e.g., having a lens design achromatized to work in the near-IR spectrum of 700 to 1100 nanometers for use with CCD or CMOS imaging circuits, or in the mid-IR range of 8 to 12 micrometers with microbolometer arrays).

In an example embodiment illustrated in FIG. 8A, an HMD system 40 employs a video camera 34 as a peripheral. The video camera 34 may be variously implemented, e.g., as a wide-field or near-field camera. In an example implementation, the video camera 34 comprises a camera pod 35, a camera base 36 and an I/O device 37. An example camera pod 35 may be implemented for rotation about its horizontal axis, toward selecting image acquisition; as shown (see the arrow in FIG. 8A), the camera pod 35 is rotated so as to acquire images in a generally downward direction (e.g., toward reading material and/or the viewer's hands). In other examples, the camera pod 35 may be (a) implemented having a fixed direction for image acquisition (i.e., no rotation supported), (b) implemented for rotation about an axis other than, or in addition to, its horizontal axis, toward selecting image acquisition, and/or (c) may be rotated about its horizontal axis for so as to acquire images in directions other than downward (e.g., forward, toward viewing straight ahead of the user).

As shown in FIG. 8A, the camera 34 is secured, via the camera base 36, to the headgear 42 at or about the front edge of the cap's visor 43. The camera 34 is coupled to the HMD assembly 44, e.g., via one or more peripherals connections 28. It is understood that the camera base 36 may otherwise secured and or coupled.

FIG. 8B shows the user's hand holding an I/O instrument 72. The I/O instrument 72 comprises an I/O assembly 74 and a base unit 76. In an example embodiment, the I/O instrument 72 may be implemented so that the I/O assembly 74 may be removably or permanently attached to the base unit 76. Where the I/O assembly 74 is removably attached, it may be implemented to attach by any of various mechanical, magnetic and/or other means. As illustrated in FIG. 8B, the I/O instrument 72 has a base unit 76 comprising a pen (held in the user's hand) and an I/O assembly 74 at the cap of the pen.

Although FIG. 8B shows base unit 76 implemented as a pen, the base unit 76 may be variously implemented. Examples include: a pencil, a stylus, one or two gloves, one or more picks, one or more finger cots, and/or one or more thimbles.

The I/O assembly 74, generally, is implemented so as to communicate with the HMD system 40, so as to enable the user to interact with the system 40. To illustrate, an example embodiment of an I/O instrument 72 may be implemented to communicate with the HMD system 40 via the I/O device 37 of video camera 34, as illustrated in FIG. 8A.

Although device 37 may be implicated in the communication, the I/O assembly 74 may be variously implemented toward realizing communication with the HMD system 40. In an example embodiment as shown in FIG. 8B, the I/O assembly 74 comprises a reflector 78, a shutter 80 and a tip 82. The reflector 78 may be variously implemented, including, e.g., using a corner-cube reflector prism, a corner-cube mirror, a so-called cat's eye (spherical) mirror, and/or retroreflector material. In this implementation, the I/O assembly 74 operates such that, responsive to the tip 82 contacting a surface, an object or other item, the shutter 80 opens so as to reveal the reflector 78. So revealed, the reflector 78 should be enabled to reflect light to the camera 34 so that the camera 34 may acquire that reflected light. In this example implementation, the shutter 80 may be variously implemented, including, e.g., as a spring-loaded shutter (i) that opens based on mechanical connection with the tip 82 upon the tip's physically contacting a real surface and (ii) that closes when the tip is removed from that surface. It is understood that, although the I/O assembly 74 may contemplate physical contact to trigger reflection, other embodiments of the I/O assembly 74 may be implemented (e.g., by virtual contact, such as by orienting and/or aligning the I/O assembly 74 relative to a virtual object with reflection triggered by an actuation mechanism, such as by a timer or by the user's gesture or by pushing a button associated with the assembly 74).

In an example embodiment, the video camera 34 sources selected light for reflection by the I/O assembly 74. The video camera 34 may be implemented to do so by implementing the I/O device 37 to comprise one or more LEDs and/or other source of light, including light of selected intensity (e.g., typically low-power light) and/or light of one or more selected wavelengths. So implemented, the I/O device 37 may be enabled to flood the camera's field of view (i.e., from a location adjacent to the camera's lens), whereby the reflector 78, when reflecting in the camera's field of view, is enabled to provide a reflected image (e.g., a relatively bright) back to the video camera 34, for acquisition in the acquired image (i.e., so as to be included in the video signal representing the acquired image). The video camera 34 and/or other components of the HMD system 40 may be enabled to detect this reflected image in the video signal by differentiating it from other parts of the video signal by any of various methods (including, e.g., if the LEDs of the camera's I/O device 37 are pulsed during alternate video frames, the reflected image may be differentially detected in the video signal).

In addition to detecting the reflected image, the video camera and/or other components of the HMD system 40 may be implemented to analyze and exploit that detected signal. As an example, the detected, reflected signal may be analyzed for its relative position in the acquired image (e.g., among horizontal and vertical pixels, among selected frames, and/or from frame to frame in selected order or sequence), so as to be exploited as an input/output (I/O) device associated with the HMD system 40. In an example embodiment, when the HMD system is used together with a computing device, the I/O instrument 72 may be used, through this reflection operation, as a form of selector, pointing device, like a mouse, or as a touch screen).

To illustrate, in FIG. 8C, the HMD system 40 may display an image of the user's hand, together with a pen functioning as the I/O instrument 72, as such image is acquired by a video camera 34. Assuming that the HMD system is used together with a computing device that is executing software (e.g., a word processing program), the HMD system 40 may display a virtual keyboard 84 (as illustrated) and/or a touch screen (not shown), and/or other items, e.g., typically to enable I/O relating to that computing device and/or its executing software. Moreover, the HMD system 40 may be implemented (i) to display, as illustrated in FIG. 8C, a window or other reference to the executing software as one part of the viewed image and (ii) to display the virtual keyboard or touch screen panel as another part of the viewed image. The HMD system 40 may so display using various methods, including e.g., by overlay, by splitting screens, and/or by using color to differentiate between the various components of the image (i.e., for clarity). In this application, the user may select any key of the virtual keyboard using the I/O instrument 72. It is understood that such selection generally will be effected depending on the implementation of the I/O instrument 72; as an example, if the I/O instrument is implemented using a shutter 80 that is opened responsive to some physical contact with a real object (e.g., a surface), the HMD system 40 may be implemented so that the user perceives the virtual keyboard overlaid on a physical surface (e.g., a desktop) in the user's surroundings, so as to enable appropriate contact with a physical object.

In another example embodiment, the HMD system 40 may provide a virtual keyboard so as to enable typing (e.g., touch typing). In such embodiment, the I/O instrument 72 may be implemented as one or two gloves, or multiple finger cots or multiple thimbles, and/or otherwise so that one or more of the user's fingertips used for typing have an associated I/O assembly 74.

It is thought that I/O instruments 72, as disclosed herein, in conjunction with the HMD assembly 44, may enable use of personal computers, laptop computers and/or other computing devices without use of a standard computer monitor and/or standard keyboard (e.g., two of the largest components of desktop and laptop computers). Moreover, it is thought that such use in portable computing devices may significantly reduce battery requirements and/or extend the time that a computing device may be operated from a given amount of battery power. It is also thought that this combination may also provide advantages and enhancements to cell phone and PDA interfacing.

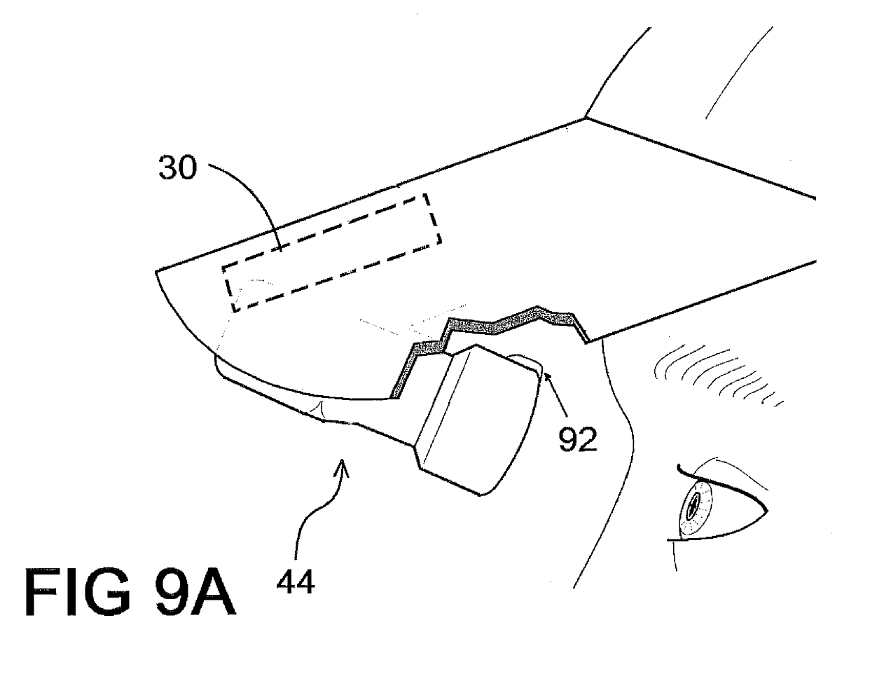

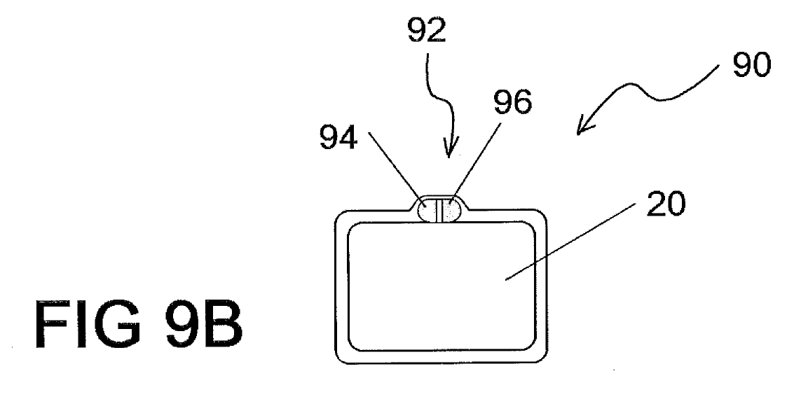

Turning to FIGS. 9A-B, an example embodiment is shown of a HMD system 40 employing a user detection technology 90. Generally, a HMD system 40 may employ user detection technology 90 for power conservation purposes (e.g., to extend operating time on battery power), e.g., by placing the system into a standby, hibernation or other power saving mode when a user is not detected. In an example embodiment, user detection technology 90 may be implemented using eye trackers.

In FIGS. 9A-B, the HMD system 40 comprises another example user detection technology 90. The technology 90 comprises a red-eye detection unit 92 that operates to place selected components of the HMD system 40 into a power saving mode when it fails to detect the user's “red eye”. The red-eye detection unit 92 comprises a paired emitter 94 and detector 96 disposed on one of the eyepieces 20 of the HMD subassembly 44, toward and relatively adjacent the user's eyes. In operation, the emitter 94 is pulsed, e.g., several times per second, which generally requires minimal power. When the user's eye is directed toward the pair, a “red eye” retroreflection is sensed by the detector 96. While the detector's corresponding “red eye” signal exceeds a selected threshold, the HMD system 40 remains activated, in whole or in part (e.g., at least selected components thereof, such as, for example, the display device 102). However, when the detector's corresponding signal falls below a selected threshold, the HMD system 40 is placed in a power savings mode. In an example embodiment, the HMD system 40 may be implemented to support plural thresholds, each such threshold corresponding to a respective one of plural power savings modes. In an example embodiment, the HMD system 40 may be implemented so that a selected time period of inactivity occurs before entering a stand-by mode associated with detection. In an example embodiment, a near-infrared LED may be employed as an emitter 94, in that the wavelengths thereof typically are invisible or substantially invisible to a user (e.g., in order to avoid or minimize user discomfort). In an example embodiment, driver/interface electronics 30 may be implemented to drive, enable, support or otherwise contribute to operation of the user detection technology feature 90 (e.g., to drive the emitter 94; to analyze the detector's “red eye” signal; to place the HMD into and take the HMD out of one or more power saving modes; and/or, to coordinate “red eye” detection with other user detection technologies and/or with other operations of various components of the HMD system 40 (e.g., general adjustment) and/or with operation or in operation of peripherals, such as an I/O instrument 72).

In this disclosure (including the accompanying drawings and appended claims), various aspects of the subject matter are described. Therein, specific components, parts, structures, arrangements, relationships, steps, operations, actions, characteristics, features, functions, numbers, ranges, systems, configurations and other details (“Specific Details”) are set forth, including to provide a thorough understanding of the subject matter. However, it should be apparent to persons having ordinary skill in the art, including those having the benefit of this disclosure, that the subject matter may be practiced without one or more of the Specific Details.

In this disclosure (including the accompanying drawings and appended claims), one or more Specific Details may be well known to a person of ordinary skill in the art. One or more of such well-known Specific Details may have been merely referenced, partly or wholly omitted and/or simplified herein, including so as to not obscure the subject matter.

As to this disclosure (including the accompanying drawings and appended claims), variations, modifications, substitutions, equivalents and/or other changes (“Changes”) are may be appreciated, recognized or otherwise understood by a person of ordinary skill in the art, having the benefit of this disclosure, including, without limitation, as to one or more of the Specific Details. Such Changes shall be considered to fall within the scope and spirit of the subject matter of this disclosure. Accordingly, the appended claims are intended to cover, and shall cover, all such Changes.

The example embodiments are, and shall be considered, illustrative; they are not, and shall not be considered, either restrictive or exhaustive. Moreover, the subject matter of this application is not, and shall not be, limited to the example embodiments, or to any one or more of the Specific Details. This disclosure (including the accompanying drawings and the appended claims) may be modified within the scope and equivalents of the original filing.

1. A lens element, comprising: a dual aspheric lens substrate having a first surface and a second surface; a diffractive/Fresnel structure associated with the first surface; and wherein the diffractive/Fresnel structure has a cross-section having a substantially non-planar characteristic.

2. A lens element as claimed in claim 1, wherein the diffractive/Fresnel structure is disposed in, on and/or at the first surface and substantially conforms to the shape of the first surface.

3. A lens element as claimed in claim 1, wherein the second surface is smooth or substantially smooth.

4. A lens element as claimed in claim 1, wherein the second surface has one of a diffractive structure, a Fresnel structure or a diffractive/Fresnel structure.

5. A lens element as claimed in claim 1, wherein a diffractive portion of the diffractive/Fresnel structure is optically equivalent or substantially equivalent to a phase profile and wherein the Fresnel portion of the diffractive/Fresnel structure is optically equivalent or substantially equivalent to a refractive sag profile.

6. A lens element as claimed in claim 1, wherein the diffractive portion of the diffractive/Fresnel structure comprises diffractive steps and, between the diffractive steps, diffractive zones, such that the depth of the diffractive steps determines the peak diffraction efficiency for a given center wavelength of a selected spectrum and for a given index of refraction of the material from which the diffractive portion is formed.

7. A lens element as claimed in claim 6, wherein the Fresnel portion of the diffractive/Fresnel structure comprises Fresnel steps and, between the Fresnel steps, Fresnel zones, and wherein the diffractive/Fresnel structure provides at least one Fresnel zone having a plurality of diffractive zones.

8. A lens element as claimed in claim 1, wherein the diffractive/Fresnel structure is disposed, in part, in, on and/or at the first surface and, in part, in, on and or at the second surface.

9. A lens element as claimed in claim 1, further comprising one or more optical components, at least one such optical component enabling imaging in the infrared spectrum, which at least one such optical component being disposed (i) either on or at the first surface and/or the second surface and/or (ii) in the substrate.

10. A lens element as claimed in claim 1, wherein the substrate comprises plastic.

11. An image viewer, comprising a lens element as claimed in claim 1.

12. A head-mounted display assembly, comprising a lens element as claimed in claim

13. A head-mounted display system, comprising a lens element as claimed in claim 1.

14. A head-mounted display system, the head-mounted display (HMD) system providing, as to image viewing, a prescribed optical performance and telecentric characteristics, the image being viewed via propagated light, the HMD system comprising:
A first relay lens, the first relay lens providing selected collimation of plural portions of propagated light;
A second relay lens, the second relay lens being optically coupled with the first relay lens and being movable relative to the first relay lens so as to enable a selected variation in distance between the first and second relay lenses; and
Wherein, within the selected variation in distance, the prescribed optical performance of the HMD system is substantially maintained.

15. A head-mounted display system as claimed in claim 14, wherein the selected variation in distance is consistent with the range of interpupilary distance associated with a selected population.

16. A head-mounted display system as claimed in claim 14, further comprising a telecentric stop.

17. A head-mounted display system as claimed in claim 16, wherein the telecentric stop is provided functionally.

18. A head-mounted display system as claimed in claim 16, wherein the second relay lens has a focal length and is disposed relative to the telecentric stop so as to provide a spacing, the spacing supporting the prescribed optical performance.

19. A head-mounted display system as claimed in claim 14, further comprising a central core, the central core including the first relay lens; and further comprising at least one subassembly, the at least one subassembly including the second relay lens; and wherein one or both of the at least one subassembly and/or the central core are movable relative to the other, so as to enable a selected variation in distance between the first and second relay lenses.

20. A head-mounted display system as claimed in claim 19, further comprising one or more folding planes, which planes may be disposed in the central core and/or subassembly.

21. A head-mounted display system as claimed in claim 19, wherein the central core is provided with a display device, the display device being optically coupled to the first relay lens.

22. A head-mounted display system as claimed in claim 21, wherein the display device is integrated in the central core.

23. A head-mounted display system as claimed in claim 21, wherein the display device is removably attachable as to the central core.

24. A head-mounted display system as claimed in claim 21, wherein the display device comprises an illumination lens, the illumination lens substantially collimating at least a portion of propagated light associated with an image.

25. A head-mounted display system as claimed in claim 19, wherein the central core comprises a nominal stop plane, the nominal stop plane providing a telecentric stop.

26. A head-mounted display system as claimed in claim 25, wherein the nominal stop plane is provided via a splitting mirror disposed in an optical path between the first relay lens and the second relay lens.

27. A head-mounted display system as claimed in claim 19, wherein the subassembly comprises an eyepiece and an intermediate image plane, the intermediate image plane being disposed in the optical path between the eyepiece and the second relay lens.

28. A head-mounted display system as claimed in claim 27, wherein the subassembly further comprises a diffuser.

29. A head-mounted display system as claimed in claim 19, wherein the at least one subassembly comprises a left subassembly and a right subassembly, the left subassembly comprising a left second relay lens and the right subassembly comprising a right second relay lens, and wherein the central core comprises a splitting mirror, the splitting mirror comprising a left splitting mirror element and a right splitting mirror element, the left splitting mirror element being disposed in an optical path between the first relay lens and the left second relay lens, the right splitting mirror element being disposed in an optical path between the first relay lens and the right second relay lens, so as to propagate light from the first relay lens to both right and left subassemblies in providing a hybrid head mounted display.

30. A head-mounted display system as claimed in claim 29, wherein the central core is provided with a display device, the display device being optically coupled to the first relay lens and having a left illumination source and a right illumination source, the left illumination source providing light for propagation through the first relay lens to the left second relay lens via the left splitting mirror element and the right illumination source providing light for propagation through the first relay lens to the right second relay lens via the right splitting mirror element.

31. A head-mounted display system as claimed in claim 29, further comprising housing/mechanics, said housing/mechanics being associated with one or more, or all, of the central core, the left subassembly and/or the right subassembly, said housing/mechanics comprising IPD adjustment technology so as to provide said relative movement and enabling the selected variation in distance between the first and second relay lenses.

32. A head-mounted display system as claimed in claim 31, wherein the housing/mechanics comprise general adjustment technology, so as to enable general adjustment.

33. A head-mounted display system as claimed in claim 32, wherein the central core comprises a rotational mirror, the rotational mirror selectively rotation in general adjustment so as to enable maintenance of optical coupling between the first relay lens and one or both of the left and right second relay lenses.

34. A head-mounted display system as claimed in claim 33, wherein the general adjustment technology and the rotational mirror provide general adjustment such that the prescribed optical performance of the HMD system is substantially maintained.

35. A modular head-mounted display system, the display system comprising: headgear, an image viewer, one or more peripherals connectors and driver/interface electronics.

36. A modular head-mounted display system as claimed in claim 35, further comprising a display device.

37. A modular head-mounted display system as claimed in claim 35, further comprising a peripheral, the peripheral being removably attached via at least one of the peripherals connectors.

38. A modular head-mounted display system as claimed in claim 37, wherein the peripheral comprises an image source.

39. A modular head-mounted display system as claimed in claim 37, wherein the image source is associated with an I/O instrument.

40. A modular head-mounted display system as claimed in claim 39, wherein the I/O instrument comprises a device remote from the headgear, which instrument enables input to and/or output from the head-mounted display system.

41. A modular head-mounted display system as claimed in claim 39, wherein the I/O instrument comprises one or more of a pen, a glove, a finger cot, a thimble and/or other structure having an associated I/O assembly.

42. A modular head-mounted display system as claimed in claim 35, further comprising user detection technology.

43. A modular head-mounted display system as claimed in claim 42, wherein the user detection technology comprises a red eye detection unit.

44. A modular head-mounted display system as claimed in claim 42, wherein the user detection technology is associated with a power control function, such that, when the user is not detected, power savings may be obtained.

45. A modular head-mounted display system as claimed in claim 35, wherein the headgear comprises a cap.
